(19) United States
(12) Patent Application Publication
(10) Pub. No.: US 2015/0253925 A1
(43) Pub. Date: Sep. 10, 2015

(54) DISPLAY CONTROL DEVICE, DISPLAY CONTROL METHOD AND PROGRAM

(71) Applicants: PANASONIC MOBILE COMMUNICATIONS CO., LTD., Yokohama-shi, Kanagawa (JP); NTT DOCOMO, INC., Chiyoda-ku, Tokyo (JP)

(72) Inventors: Masatoshi Nakao, Kanagawa (JP); Hiroyuki Sato, Kanagawa (JP); Masashi Tagaya, Tokyo (JP); Yasuo Morinaga, Tokyo (JP); Masaki Itou, Tokyo (JP)

(73) Assignees: PANASONIC MOBILE COMMUNICATIONS CO., LTD., Kanagawa (JP); NTT DOCOMO, INC., Tokyo (JP)

(21) Appl. No.: 14/431,372

(22) PCT Filed: Sep. 27, 2013
(86) PCT No.: PCT/JP2013/005795

§ 371 Date: Mar. 26, 2015

(30) Foreign Application Priority Data
Sep. 28, 2012 (JP) 2012-217711

(51) Int. Cl. G06F 3/041; G06F 3/0488

(52) U.S. Cl. CPC G06F 3/0418; G06F 3/0488; G06F 2203/04101

(57) ABSTRACT

Support information or related information regarding an input operation target is explicitly displayed when the proximity is detected before a user selects and fixes an input operation target, so as to support a user's accurate input operation, thereby improving operability. A portable terminal includes a proximity detection unit that detects a proximity of the finger to a screen, and a key image combining unit that displays enlarged images of an item displayed at a proximity correspondence position on the screen and all items adjacent to the item at the proximity correspondence position which is a position on the screen corresponding to proximity coordinates of the finger of which the proximity is detected, or in a vicinity of the proximity correspondence position, as related information or support information regarding the item displayed at the proximity correspondence position on the screen.

### TECHNICAL FIELD

The present invention relates to a display control device, a display control method and a program, which support an input operation using a touch panel.

### BACKGROUND ART

In recent years, the number of electronic apparatuses equipped with touch panels has increased. The touch panel which can provide an intuitive user interface to a user is widely used as a device which receives an input operation on an electronic apparatus including a mobile phone or a smartphone. The touch panel enables both reception of an input operation on a screen of a display unit (for example, liquid crystal display (LCD)) or an electroluminescent (EL) display) provided in an electronic apparatus and display of an operation execution result of the input operation, to be performed on the same screen.

In addition, in recent years, a touch panel which can detect the proximity of a finger is known (for example, refer to Patent Literature 1). A noncontact type user input device disclosed in Patent Literature 1 includes a plurality of linear transmission electrodes, a transmitter which supplies an

AC current for transmission to each of the transmission electrodes, a plurality of linear reception electrodes which are disposed so as not to make contact with the respective transmission electrodes, and a receiver which receives AC current flowing through the reception electrode. A capacitor is formed at each intersection between the transmission electrode and the reception electrode. Further, since a capacitor is formed according to the proximity of the fingertip of a user, a capacitance value of the capacitor changes depending on degree of proximity of the fingertip. The noncontact user input device can recognize the distance between the touch panel and the finger on the basis of the change in the capacitance value.

The touch panel as disclosed in Patent Literature 1 can detect a state in which the finger is held over at a position in a space which is lower than a predetermined height from a horizontal surface of the touch panel, that is, a proximity state of the finger and the touch panel, and can detect a case where a sliding operation is performed with the finger in the space approximately in parallel with respect to the touch panel in the same manner as in a case where a sliding operation is performed in a state where the finger is directly touched on the touch panel on the basis of a capacitance value which is specified depending on the distance between the finger and the touch panel. For this reason, a touch panel which can detect the proximity of the finger is expected to be established as a new user interface.

### CITATION LIST

### Patent Literature

Patent Literature 1: JP-A-2002-342033

### SUMMARY OF INVENTION

### Technical Problem

However, in the touch panel of the related art, there is a problem in that a user does not know what kind of operation will be executed until the user performs a certain input operation on the touch panel in an application. For example, there may be case where a user as a beginner uses an application which is not used much, and the user who is unaccustomed to the functions of buttons such as icons displayed on a screen performs a touch operation on the buttons, and as a result, an operation which is not intended by the user is executed, and thus the user makes operation errors.

In addition, Patent Literature 1 does not particularly disclose an operation in the above-described use case, that is, a proximity operation is performed on the buttons such as icons displayed on the screen when the user uses the application which is not used much. However, the same problem described in the above use case may also occur in the touch panel which can detect the proximity of the finger.

The present invention has been made in consideration of the above-described circumstances, and an object thereof is to provide a display control device, a display control method and a program, which explicitly display support information or related information regarding an input operation target when the proximity is detected before a user selects and fixes an input operation target, so as to support a user's accurate input operation, thereby improving operability.

### Solution to Problem

A display control device according to one aspect of the present invention includes: a display unit that displays data on a screen; a proximity detection unit that detects proximity of a finger to the screen and outputs a proximity detection signal; a contact detection unit that detects a contact of the finger on the screen; a display control unit that displays related information or support information regarding an item displayed at a proximity correspondence position on the screen, at the proximity correspondence position or in the vicinity of the proximity correspondence position with reference to the proximity detection signal, wherein the proximity correspondence position is a position on the screen corresponding to the proximity detection signal for the finger of which the proximity is detected; and an operation execution unit that executes an operation corresponding to an item falling in a contact position where a contact of the finger on the related information or the support information is detected in accordance with the contact of the finger.

According to this configuration, since related information or support information regarding an item (for example, a button) displayed at a proximity correspondence position which is a position on a screen located downward in the vertical direction of the finger is displayed at the proximity correspondence position or in the vicinity thereof when the proximity of the finger to the screen is detected, it is possible to explicitly display support information or related information regarding an input operation target when the proximity is detected before a user selects and fixes an input operation target, so as to support a user's accurate input operation, thereby improving operability.

A display control method according to one aspect of the present invention is a display control method for a display control device which displays data on a screen, and the method includes the steps of: detecting proximity of a finger to the screen and outputs a proximity detection signal; displaying related information or support information regarding an item displayed at a proximity correspondence position on the screen, at the proximity correspondence position or in a vicinity of the proximity correspondence position with reference to the proximity detection signal, wherein the proximity correspondence position is a position on the screen corresponding to the proximity detection signal for the finger of which the proximity is detected; detecting a contact of the finger on the screen; and executing an operation corresponding to an item falling in the proximity correspondence position or a contact position where the contact is detected in accordance with the proximity of the finger to or the contact of the finger on the related information or the support information.

According to this method, since related information or support information regarding an item (for example, a button) displayed at a proximity correspondence position which is a position on a screen located downward in the vertical direction of the finger is displayed at the proximity correspondence position or in the vicinity thereof when the proximity of the finger to the screen is detected, it is possible to explicitly display support information or related information regarding an input operation target when the proximity is detected before a user selects and fixes an input operation target, so as to support a user's accurate input operation, thereby improving operability.

An aspect of the present invention is a program causing a computer which is a display control device which displays data on a screen, to execute the steps of; detecting proximity of a finger to the screen and outputs a proximity detection signal; displaying related information or support information regarding an item displayed at a proximity correspondence position on the screen, at the proximity correspondence position or in the vicinity of the proximity correspondence position with reference to the proximity detection signal, wherein the proximity correspondence position is a position on the screen corresponding to the proximity detection signal for the finger of which the proximity is detected; detecting a contact of the finger on the screen; and executing an operation corresponding to an item falling in the proximity correspondence position or a contact position where the contact is detected in accordance with the proximity of the finger to or the contact of the finger on the related information or the support information.

According to this program, since related information or support information regarding an item (for example, a button) displayed at a proximity correspondence position which is a position on a screen located downward in the vertical direction of the finger is displayed at the proximity correspondence position or in the vicinity thereof when the proximity of the finger to the screen is detected, it is possible to explicitly display support information or related information regarding an input operation target when the proximity is detected before a user selects and fixes an input operation target, so as to support a user's accurate input operation, thereby improving operability.

### ADVANTAGEOUS EFFECTS OF INVENTION

According to the present invention, it is possible to explicitly display support information or related information regarding an input operation target when the proximity is detected before a user selects and fixes an input operation target, so as to support a user's accurate input operation, thereby improving operability.

### BRIEF DESCRIPTION OF DRAWINGS

FIG. 1 is a block diagram illustrating a functional configuration of a portable terminal 1 according to a first embodiment.

FIG. 2 is a diagram illustrating a state in which a “C” key which is a proximity correspondence key and all keys adjacent to the “C” key are simultaneously enlargedly displayed.

FIG. 3 is a diagram illustrating timing at which display content of all enlargedly displayed keys changes when the finger is moved (hover-slide operation).

FIG. 4 is a diagram illustrating a display position of an enlargedly displayed key as a center among all the enlargedly displayed keys which are displayed in a changing manner according to the movement (hover-slide operation) of the finger.

FIG. 5(A) is a flowchart illustrating an operation procedure of the portable terminal 1 according to the first embodiment, and FIG. 5(B) is a flowchart illustrating an operation procedure in which a key at a proximity correspondence position is enlargedly displayed in the operation procedure illustrated in FIG. 5(A).

FIG. 6 is a block diagram illustrating a functional configuration of a portable terminal 1A according to a second embodiment.

FIG. 7 is a diagram illustrating a state in which an “ [symbol] ” key of hiragana characters, which is a proximity correspondence key of the finger FG and related keys of the “ [symbol] ” key of hiragana characters are displayed.

FIG. 8 is a flowchart illustrating operation procedures of the portable terminal 1A according to the second embodiment.

FIG. 9 is a block diagram illustrating a functional configuration of a portable terminal 1B according to a third embodiment.

FIG. 10 is a diagram illustrating a state in which a menu list of the same group corresponding to a simple button displayed at a proximity correspondence position is displayed in a display form which can be visually recognized by a user in a case where the finger FG approaches the simple button of the setting changing items.

FIG. 11 is a diagram illustrating a state in which the finger FG approaches a moving image capturing button which is a button of an operation execution item for a predetermined or more time.

FIG. 12 is a flowchart illustrating an operation procedure of a portable terminal 1C according to a third embodiment.

FIG. 13 is a block diagram illustrating a functional configuration of a portable terminal according to a fourth embodiment.

FIG. 14(A) is a diagram illustrating a security lock screen and nine detection points provided in a touch panel, FIG. 14(B) is a conceptual diagram illustrating a touch detection region, a low hovering detection region, and a high hovering detection region, and FIG. 14(C) is a diagram illustrating detection points provided in the respective regions and the trajectory of the finger.

FIG. 15 is a diagram illustrating a display form of a trajectory of a cancellation operation using the finger FG with respect to a security lock screen and a display form of the trajectory position (height).

FIG. 16 is a flowchart illustrating an operation procedure of the portable terminal 1C according to the fourth embodiment.

FIG. 17 is a diagram illustrating a screen display example of an input trajectory of the finger FG in a case where a total of two or three detection points in a z axis direction of the touch detection region, the low hovering detection region, and the high hovering detection region are regarded as a single detection point, in which FIG. 17(A) is a diagram illustrating detection points provided in the respective detection regions and the trajectory of the finger, FIG. 17(B) illustrates a screen display example of the trajectory of the finger FG (refer to FIG. 17(A)) in a case where three detection points in the z axis direction of all the detection regions are regarded as a single detection point, FIG. 17(C) illustrates a screen display example of the trajectory of the finger FG (refer to FIG. 17(A)) in a case where two detection points in the z axis direction of the low hovering detection region and the high hovering detection region are regarded as a single detection point, and FIG. 17(D) illustrates a screen display example of the trajectory of the finger FG (refer to FIG. 17(A)) in the touch detection region.

### DESCRIPTION OF EMBODIMENTS

Hereinafter, respective embodiments of a display control device, a display control method, and a program related to the present invention will be described with reference to the drawings. The display control device related to the present invention is an electronic apparatus including a display unit which displays data on a screen, and is, for example, a mobile phone, a smartphone, a tablet terminal, a digital still camera, a personal digital assistant (PDA), or an electronic book terminal. Hereinafter, a description will be made by using a portable terminal (for example, a smartphone) as an example of the display control device for describing each embodiment.

In addition, the present invention can be represented as a display control device in terms of a device, or a program causing a computer to function as the display control device in order to execute each of the operations (steps) executed by the display control device. Further, the present invention can be represented as a display control method including each of the operations (steps) executed by the display control device. In other words, the present invention can be represented as any category of device, method, and program.

### Description of Terminologies Necessary in Each Embodiment

In addition, in the following description, an item which allows a user's input operation to be received and allows some content items of each application displayed on a screen of a display unit (for example, an LCD or an organic EL display) of a portable terminal to be selected, or an item for performing a predetermined operation related to a content item through the selection, is defined as a “button”. The predetermined operation is, for example, an operation (for example, an operation of reproducing video data) of executing the content related to a currently displayed content item in an application.

A “button” as a portion giving an instruction for operating an application or changing settings from a user may be hyper-linked text, that is, a headline of news, for example, in a case where the headline of news is displayed as a content item of the application, or may be an image (for example, an icon) for prompting the user to perform a selection operation, or may be a combination of text and an image. The portable terminal receives selection of, for example, a “headline of news” corresponding to a button as an input operation on the button in response to a user's input operation, and displays details of the news corresponding to the selected button. In addition, the “button” is specified according to an application which is activated in the portable terminal.

In the following description, the description will be made by using a user's finger (for example, the index finger) as an example of an indication medium (detection target) on a touch panel, but an indication medium is not limited to the finger, and a conductive stylus gripped by a user's hand may be used. In addition, an indication medium (detection target) is not particularly limited as long as the indication medium can detect proximity and touch (contact) on a touch panel according to a structure and a detection method of the touch panel.

In addition, two axes representing a horizontal surface of a touch panel are set as an x axis and a y axis, and an axis representing a direction (height direction) with respect to the horizontal plane on the touch panel is set as a z axis. Further, in the following description, “coordinates” indicate either touch coordinates (x,y) specified by a position on the horizontal surface of the touch panel when the touch panel detects touching (contact) of the finger or proximity coordinates (x, y, z) specified by a position in a space when the touch panel detects the proximity of the finger. A z coordinate value of the proximity coordinates indicates a height at which the finger is separated from the horizontal surface of the touch panel in the space.

In addition, in the following description, an operation of holding up the finger at a position within a proximity detection region in a space separated in a separated direction from the horizontal surface of the touch panel is defined as a “hover operation”, and an operation of sliding (moving) the finger approximately in parallel to the horizontal surface of the touch panel is defined as a “hover-slide operation”. Therefore, an operation in which the finger is directly touched on the surface of the touch panel is not a “hover operation” but a “touch operation”. Further, an operation in which the finger touches (comes into contact with) the horizontal surface of the touch panel and is then slid (moved) along the horizontal surface is defined as a “touch-slide operation”.

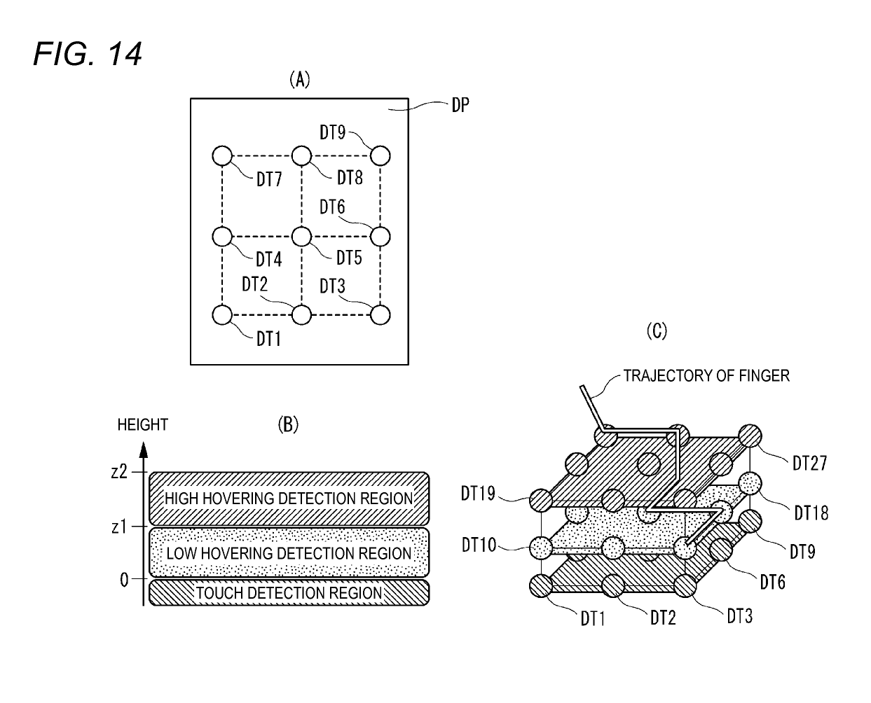

Still further, in order to detect a hover operation or a hover-slide operation, the distance between the finger and the touch panel preferably corresponds to a range of a capacitance value which can be detected by the touch panel since the distance is in inverse proportion to the capacitance value which is detected by the touch panel. For this reason, a proximity detection region (z coordinate value: z3) in which the proximity of the finger can be detected is set in advance in touch panels provided in portable terminals of the following respective portable terminals (refer to FIG. 14(B)). If the finger is directed toward the touch panel and enters the proximity detection region, the touch panel detects the proximity of the finger. As mentioned above, an operation in which the finger is held up from a height outside the proximity detection region to a height inside the proximity detection region toward the touch panel is referred to as a “hover-in operation”. An operation in which the finger is moved from the inside of the proximity detection region to the outside of the proximity detection region so as to be separated from the touch panel, whereby the proximity of the finger is not detected, is referred to as a “hover-out operation”.

### First Embodiment

In a first embodiment, in a case where the finger approaches any one of the keys of a QWERTY type software keyboard displayed on a screen, a portable terminal 1 enlargedly displays a key displayed at a proximity correspondence position and all keys adjacent to the key as related information or support information regarding an item (for example, an alphabet “C” key) displayed at the proximity correspondence position around the position (hereinafter, referred to as the “proximity correspondence position”) on the screen corresponding to proximity coordinates of the finger with which a hover operation or a hover-slide operation is being performed.

### Functional Configuration of Portable Terminal 1 According to First Embodiment

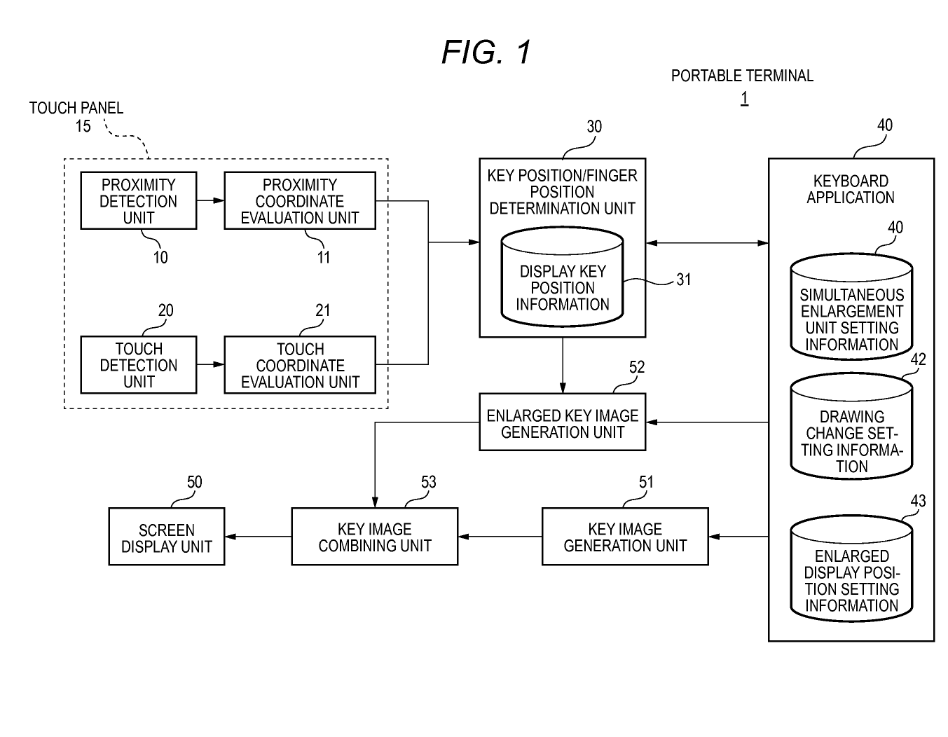

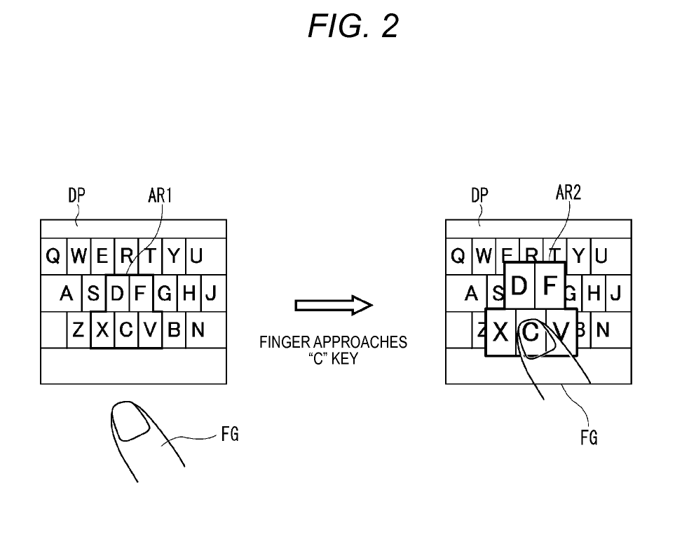

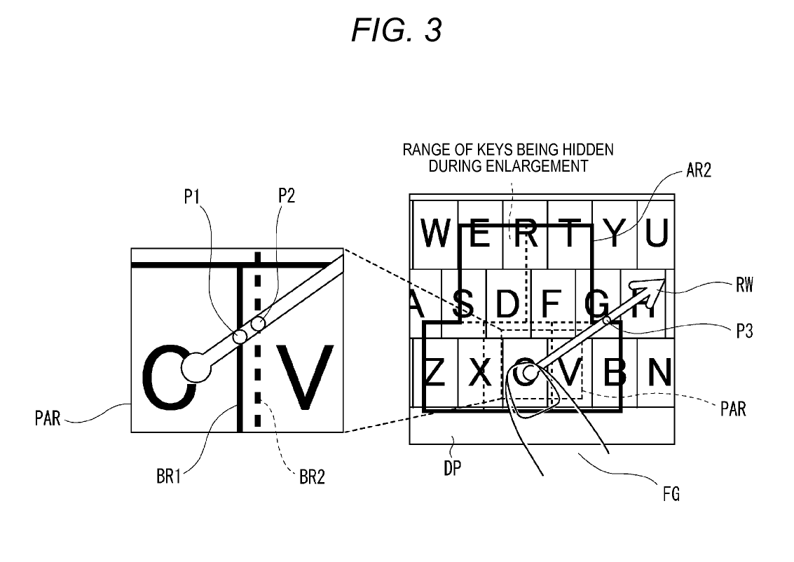

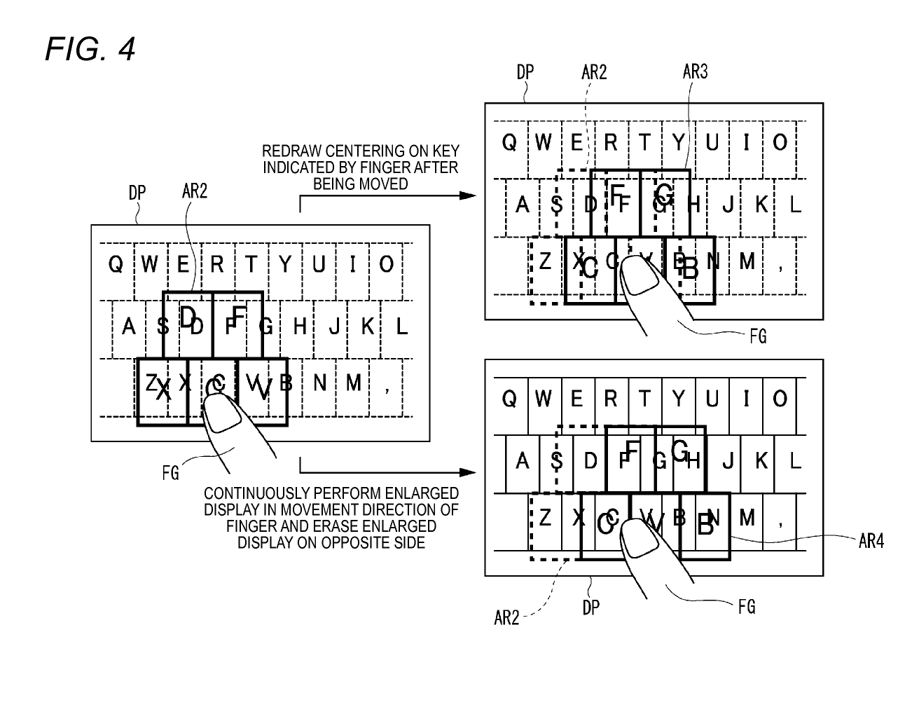

First, with reference to FIG. 1, a functional configuration of the portable terminal 1 according to the first embodiment will be described. FIG. 1 is a block diagram illustrating a functional configuration of the portable terminal 1 according to the first embodiment. The portable terminal 1 illustrated in FIG. 1 includes a proximity detection unit 10, a proximity coordinate evaluation unit 11, a touch detection unit 20, a touch coordinate evaluation unit 21, a key position/finger position determination unit 30, a keyboard application 40, a screen display unit 50, a key image generation unit 51, an enlarged key image generation unit 52, and a key image combining unit 53. The key position/finger position determination unit 30 holds display key position information 31. The keyboard application 40 holds simultaneous enlargement unit setting information 41 (refer to FIG. 2), drawing change setting information 42 (refer to FIG. 3), and enlarged display position setting information 43 (refer to FIG. 4).

Each of the key position/finger position determination unit 30, keyboard application 40, the key image generation unit 51, the enlarged key image generation unit 52, and the key image combining unit 53 can be operated by a processor (not illustrated) built into the portable terminal 1 reading and executing a program related to the present invention. In addition, the processor is, for example, a central processing unit (CPU), a micro-processing unit (MPU), or a digital signal processor (DSP), and is also the same for the following respective embodiments.

The proximity detection unit 10 detects that a user's finger FG (refer to FIG. 2) approaches a touch panel 15 through a hover operation or hover-slide operation. The proximity detection unit 5 sends a proximity notification indicating that the finger approaches the touch panel 15 to the proximity coordinate evaluation unit 11.

The proximity coordinate evaluation unit 11 calculates proximity coordinates (x, y, z) of the finger FG to the touch panel 15 as a proximity detection signal during the detection of the proximity on the basis of the proximity notification sent from the proximity detection unit 10. In addition, in the following description, a proximity detection signal will be described by using proximity coordinates, but a capacitance value calculated when the proximity is detected may be used. As described above, in the proximity coordinates (x, y, z), the x component and the y component are coordinate values indicating a position on the horizontal surface of the touch panel 15 mounted on a screen DP (refer to FIG. 2) of the screen display unit 50, that is, coordinate values indicating a proximity correspondence position, and the z component is a coordinate value indicating a distance (height) in the z axis direction between the finger FG and the touch panel 15. The proximity coordinate evaluation unit 11 outputs information regarding the calculated proximity coordinates (x, y, z) to the key position/finger position determination unit 30. Further, the proximity detection unit 10 and the proximity coordinate evaluation unit 11 may be collectively configured as a proximity detection unit.

The touch detection unit 20 as a contact detection unit detects an operation in which the finger FG touches (comes into contact with) the touch panel 15 through a touch operation or a touch-slide operation. The touch detection unit 20 sends a contact notification indicating that the finger FG touches (comes into contact with) the touch panel 15 to the touch coordinate evaluation unit 21.

The touch coordinate evaluation unit 21 calculates touch coordinates (x,y) when the finger FG touches (comes into contact with) the touch panel 15 on the basis of the contact notification sent from the touch detection unit 20. The touch coordinate evaluation unit 21 outputs information regarding the calculated touch coordinates (x,y) to the key position/finger position determination unit 30. In addition, the touch detection unit 20 and the touch coordinate evaluation unit 21 may be collectively configured as a touch detection unit.

In the respective embodiments including the present embodiment, the touch panel 15 which can detect both the touching (contact) and the proximity of the finger FG may be configured by using the proximity detection unit 10, the proximity coordinate evaluation unit 11, the touch detection unit 20, and the touch coordinate evaluation unit 21.

The key position/finger position determination unit 30 determines an x coordinate value and a y coordinate value of the proximity coordinates (x, y, z), that is, a key (hereinafter, referred to as a “proximity correspondence key”) which is displayed at a proximity correspondence position of the finger FG with which the hover operation or the hover-slide operation is being performed, on the basis of the proximity coordinates (x, y, z) output from the proximity coordinate evaluation unit 11 and the display key position information 31.

In a case where a QWERTY type software keyboard is displayed on the screen DP (refer to FIG. 2) of the screen display unit 50 which will be described later, the display key position information 31 is information indicating a display position of the same software keyboard in the screen DP and a display position of each of the keys forming the same software keyboard.

In addition, the display key position information 31 is held in the key position/finger position determination unit 30 but may be held in the keyboard application 40. In this case, the key position/finger position determination unit 30 outputs the information regarding the proximity coordinates (x, y, z) which is output from the proximity coordinate evaluation unit 11, to the keyboard application 40. The keyboard application 40 determines information regarding a proximity correspondence key displayed at a proximity correspondence position on the basis of the display key position information 31 and the information output from the key position/finger position determination unit 30, and outputs the determined information to the key position/finger position determination unit 30.

The key position/finger position determination unit 30 determines the proximity correspondence key, then inquires of the keyboard application 40 information regarding the number of keys which are enlargedly displayed simultaneously with the determined proximity correspondence key, and outputs an enlarged key image generation instruction indicating that enlarged key images (data) of a plurality of keys be generated including the proximity correspondence key, to the enlarged key image generation unit 52.

The keyboard application 40 as an operation execution unit is an application which is stored in advance in a read only memory (ROM) built into the portable terminal 1, causes the key image generation unit 51 to generate screen data of, for example, a QWERTY type software keyboard, and receives a user's input operation (for example, a text input operation) on the QWERTY type software keyboard displayed on the screen DP.

The keyboard application 40 outputs the information regarding the number of keys which are enlargedly displayed simultaneously with the proximity correspondence key to the key position/finger position determination unit 30 as response information to the inquiry from the key position/finger position determination unit 30 on the basis of the simultaneous enlargement unit setting information 41.

The simultaneous enlargement unit setting information 41 is information indicating the number of keys which are enlargedly displayed simultaneously with the proximity correspondence key, and is information indicating “all” keys adjacent to the proximity correspondence key in the present embodiment. FIG. 2 is a diagram illustrating a state in which all keys adjacent to the “C” key are enlargedly displayed simultaneously with the “C” key which is the proximity correspondence key.

For example, if the finger FG approaches the “C” key displayed on the screen DP, the “C” key becomes a proximity correspondence key. The keyboard application 40 outputs, to the key position/finger position determination unit 30, number information (=four) indicating that information regarding the number of keys which are enlargedly displayed simultaneously with the proximity correspondence key represents all keys adjacent to the proximity correspondence key, as response information, on the basis of the simultaneous enlargement unit setting information 41. The key position/finger position determination unit 30 determines that the keys enlargedly displayed simultaneously with the proximity correspondence key (the “C” key) are “X”, “V”, “D” and “F” keys on the basis of the response information from the keyboard application 40 and the display key position information 31. Further, the key position/finger position determination unit 30 determines that the proximity correspondence key (the “C” key) and the keys (the “X”, “V”, “D” and “F” keys) enlargedly displayed simultaneously with the proximity correspondence key are targets generated by the enlarged key image generation unit 52. The key position/finger position determination unit 30 outputs an enlarged key image generation instruction for generating enlargedly displayed key images of the proximity correspondence key (the “C” key) and all the keys (the “X”, “V”, “D” and “F” keys) adjacent to the proximity correspondence key, to the enlarged key image generation unit 52.

Therefore, as illustrated in FIG. 2, if the finger FG approaches the “C” key displayed on the screen DP, the portable terminal 1 enlargedly displays the “C” key and all the keys (the “X”, “V”, “D” and “F” keys) adjacent to the “C” key surrounded by a region AR1, with the same magnification, centering on the display position of the “C” key before being enlargedly displayed (refer to a region AR2 illustrated in FIG. 2). Consequently, in a case where respective keys are displayed so as to be adjacent thereto in the QWERTY type software keyboard, the portable terminal 1 enlargedly displays a specific key and keys adjacent to the specific keys in all directions altogether and can thus allow peripheral keys through a user whose finger FG approaches the key to be easily selected.

Hereinafter, in the QWERTY type software keyboard, a key which is enlargedly displayed is referred to as an “enlargedly displayed key”. In addition, a part of the QWERTY type software keyboard (specifically, all of the “X”, “C”, “V”, “D” and “F” keys, and parts of “Z”, “S”, “E”, “R”, “T”, “G” and “B” keys) is hidden by the region AR2 of all the enlargedly displayed keys which are enlargedly displayed (refer to the right side of the arrow of FIG. 2).

Next, the drawing change setting information 42 is information indicating timing at which display content of all enlargedly displayed keys changes according to the movement of the finger FG in a case where the finger FG with which a hover operation is being performed is moved in parallel to the screen DP (a hover-slide operation), and is predefined in an operation of the keyboard application 40. However, the drawing change setting information 42 may be changed as appropriate by a user's setting changing operation. FIG. 3 is a diagram illustrating timing at which display content of all enlargedly displayed keys changes when the finger FG is moved (a hover-slide operation). A left region PAR illustrated in FIG. 3 is an enlargedly displayed region of a right dotted region PAR illustrated in the same figure.

The drawing change setting information 42 is any one of information pieces indicating the following three kinds of timings. This will be described in detail with reference to FIG. 3.

The first timing is a timing at which the finger FG exceeds a point P1 on a boundary BR1 of a display region of the “C” key before being enlargedly displayed when the finger FG with which a hover operation is being performed on the “C” key is moved (a hover-slide operation) in the direction of an arrow RW. In other words, the key position/finger position determination unit 30 outputs the information regarding the proximity coordinates (x, y, z) output from the proximity coordinate evaluation unit 11, to the keyboard application 40. The keyboard application 40 outputs information indicating that the proximity coordinates (x, y, z) satisfy the first timing of the drawing change setting information 42 to the enlarged key image generation unit 52 on the basis of the proximity coordinates (x, y, z) output from the key position/finger position determination unit 30. Consequently, the portable terminal 1 enables an expert user who can perform consecutive input operations even if the finger FG does not hover out, to understand and recognize a change in display content of the enlargedly displayed key at the time when the finger exceeds a boundary of a key which is not enlargedly displayed with the original magnification. Therefore, it is possible to improve a user's operability.

The second timing is a timing at which the finger FG exceeds a point P2 on a boundary BR2 of a display region of the “C” key after being enlargedly displayed when the finger FG with which a hover operation is being performed on the “C” key is moved (a hover-slide operation) in the direction of the arrow RW. In other words, the key position/finger position determination unit 30 outputs the information regarding the proximity coordinates (x, y, z) output from the proximity coordinate evaluation unit 11, to the keyboard application 40. The keyboard application 40 outputs information indicating that the proximity coordinates (x, y, z) satisfy the second timing of the drawing change setting information 42 to the enlarged key image generation unit 52 on the basis of the proximity coordinates (x, y, z) output from the key position/finger position determination unit 30. Consequently, the portable terminal 1 enables even a user who is not an expert to explicitly understand and recognize a change in display content of the enlargedly displayed key at the time when the finger exceeds the boundary BR2 of the enlargedly displayed key “C” which is actually displayed on the screen DP. Therefore, it is possible to reduce operation errors by the user and thus to improve the user's operability.

The third timing is a timing at which the finger FG exceeds a point P3 on a boundary corresponding to an outer line of a display region of the region AR2 of all the enlargedly displayed keys when the finger FG with which a hover operation is being performed on the “C” key is moved (a hover-slide operation) in the direction of the arrow RW. In other words, the key position/finger position determination unit 30 outputs the information regarding the proximity coordinates (x, y, z) output from the proximity coordinate evaluation unit 11, to the keyboard application 40. The keyboard application 40 outputs information indicating that the proximity coordinates (x, y, z) satisfy the third timing of the drawing change setting information 42 to the enlarged key image generation unit 52 on the basis of the proximity coordinates (x, y, z) output from the key position/finger position determination unit 30. Consequently, the portable terminal 1 enables a user such as a beginner who is not accustomed to a hover operation or a hover-slide operation to explicitly understand and recognize a change in display content of the enlargedly displayed key at the time when the finger exceeds the outer line boundary of the region AR2 of the enlargedly displayed keys which are actually displayed on the screen DP. Therefore, it is possible to reduce operation errors by the user and thus to improve the user's operability.

As mentioned above, since the movement speed during the movement of the finger FG with respect to the touch panel 15 (during a hover-slide operation) differs depending on a hover operation skill or a hover-slide operation skill of a user, the portable terminal 1 sets the drawing change setting information 42 which is suitable for the skill or preference of the user to be used by the user, and can thus appropriately perform changes of enlargedly displayed keys in consideration of convenience for the user.

Next, the enlarged display position setting information 43 is information indicating a display position of an enlargedly displayed key as the center when display content of enlargedly displayed keys changes according to the movement of the finger FG in a case where the proximity coordinates (x, y, z) satisfy the timing of the drawing change setting information 42. FIG. 4 is a diagram illustrating a display position of an enlargedly displayed key as a center among all enlargedly displayed keys which are displayed in a changing manner according to the movement (a hover-slide operation) of the finger FG.

The enlarged display position setting information 43 is information indicating the following two display positions. This will be described in detail with reference to FIG. 4. First, it is assumed as a premise of operation that the finger FG with which a hover operation is being performed is moved (a hover-slide operation) from the “C” key before being enlargedly displayed and enters a display region of the “V” key before being enlargedly displayed after exceeding a boundary between the “C” key before being enlargedly displayed and the “V” key before being enlargedly displayed. In other words, in description of FIG. 4, for simplification of the description and content of FIG. 4, the drawing change setting information 42 used to change display content of an enlargedly displayed key is assumed to be information indicating the first timing.

A first display position is a display position of a key (the “V” key) before being enlargedly displayed, which is displayed at a proximity correspondence position of the finger FG after being moved (a hover-slide operation) in a case where the finger FG is moved (a hover-slide operation) as the above-described premise. In other words, the key position/finger position determination unit 30 outputs the information regarding the proximity coordinates (x, y, z) output from the proximity coordinate evaluation unit 11, to the keyboard application 40, in a case where the finger FG is moved (a hover-slide operation) as the above-described premise. Further, the keyboard application 40 outputs, to the enlarged key image generation unit 52, information indicating that information regarding a display position of an enlargedly displayed key as the center when display content of an enlargedly displayed key changes according to the movement of the finger FG is “a display position of the “V” key before being enlargedly displayed, which is displayed at the proximity correspondence position of the finger FG after being moved (a hover-slide operation)”, when the proximity coordinates (x, y, z) satisfy the first timing of the drawing change setting information 42, on the basis of the proximity coordinates (x, y, z) output from the key position/finger position determination unit 30. Therefore, in a case where the finger FG is moved (a hover-slide operation) as the above-described premise, the portable terminal 1 enlargedly displays (draws) the “V” key as a proximity correspondence key and all keys (the “C”, “B”, “F” and “G” keys) adjacent to the “V” key centering on the display position of the “V” key before being enlargedly displayed, which is displayed at the proximity correspondence position of the finger FG after being moved (a hover-slide operation) (refer to the upper right part of FIG. 4).

A second display position is a display position of an enlargedly displayed key which is displayed at a proximity correspondence position of the finger FG after being moved among initial display positions of all enlargedly displayed keys which have been displayed before the movement (a hover-slide operation) of the finger FG in a case where the finger FG is moved (a hover-slide operation) as the above-described premise. In addition, in a case where the enlarged display position setting information 43 is information indicating a second display position, display of enlargedly displayed keys of all keys (the “B” and “G” keys) adjacent in the movement (a hover-slide operation) direction of the “V” key after being enlargedly displayed, which is displayed at the proximity correspondence position of the finger FG after being moved, is added (continuously performed), and the display of the enlargedly displayed keys of all the keys (the “C” and “F” keys) adjacent on an opposite side to the same movement (a hover-slide operation) direction is erased. In other words, the key position/finger position determination unit 30 outputs the information regarding the proximity coordinates (x, y, z) output from the proximity coordinate evaluation unit 11, to the keyboard application 40, in a case where the finger FG is moved (a hover-slide operation) as the above-described premise. Further, the keyboard application 40 outputs, to the enlarged key image generation unit 52, information indicating that information regarding a display position of an enlargedly displayed key as the center when display content of an enlargedly displayed key changes according to the movement of the finger FG is “an initial display position of an enlargedly displayed key (the “V” key) which is displayed at a proximity correspondence position of the finger FG after being moved (a hover-slide operation) among initial display positions of all enlargedly displayed keys which have been displayed before the movement (a hover-slide operation) of the finger FG”, when the proximity coordinates (x, y, z) satisfy the first timing of the drawing change setting information 42, on the basis of the proximity coordinates (x, y, z) output from the key position/finger position determination unit 30. Therefore, in a case where the finger FG is moved (a hover-slide operation) as the above-described premise, the portable terminal 1 additionally displays the enlargedly displayed keys of all the keys (the “B” and “G” keys) adjacent in the movement (a hover-slide operation) direction and erases the enlargedly displayed keys of all the keys (the “C” and “F” keys) adjacent on an opposite side to the movement (a hover-slide operation) direction centering on the initial display position of the proximity correspondence key (the “V” key) of the finger FG after being moved (a hover-slide operation) (refer to the lower right part of FIG. 4).

As mentioned above, since the portable terminal 1 sets the enlarged display position setting information 43 which is suitable for the skill or preference of the user to be used by the user, according to the enlarged display position setting information 43 indicating the first display position, it is possible to further reduce a movement amount of the finger FG when display content of an enlargedly displayed key is changed according to the movement (a hover-slide operation) of the finger FG than in a case of using the enlarged display position setting information 43 indicating the second display position, and thus to simplify a user's operation.

In addition, according to the enlarged display position setting information 43 indicating the second display position, the portable terminal 1 additionally displays all keys adjacent in a movement direction of the finger FG without changing display positions of enlargedly displayed keys which have already been displayed, and deletes all keys adjacent in an opposite direction to the movement direction, and thus it is possible to improve visibility of all enlargedly displayed keys after the movement (a hover-slide operation) of the finger FG.

The screen display unit 50, which is configured by using, for example, an LCD or an organic EL display, has a function of displaying data on the screen DP, and displays screen data output from the key image combining unit 53 which will be described later, on the screen DP. In the present embodiment, the screen data displayed by the screen display unit 50 is data regarding a screen of a QWERTY type software keyboard, or data regarding a screen in which a screen of the QWERTY type software keyboard is combined with enlargedly displayed keys.

The key image generation unit 51 generates screen data of a QWERTY type software keyboard (refer to FIG. 2) on the basis of a screen data generation instruction of the same type software keyboard, which is output from the keyboard application 40, and outputs the generated screen data to the key image combining unit 53.

The enlarged key image generation unit 52 generates image data of an enlargedly displayed key on the basis of an enlarged key image generation instruction output from the key position/finger position determination unit 30, and outputs the image data to the key image combining unit 53. In addition, the enlarged key image generation unit 52 generates image data of enlargedly displayed keys after the movement (a hover-slide operation) of the finger FG on the basis of the enlarged key image generation instruction output from the key position/finger position determination unit 30 and each of the information pieces output from the keyboard application 40, and outputs the generated image data to the key image combining unit 53. Further, each of the information pieces output from the keyboard application 40 includes information that the drawing change setting information 42 is satisfied, and information regarding a display position of an enlargedly displayed key as a center when display content of an enlargedly displayed key changes according to a movement of the finger FG. Still further, the enlarged key image generation unit 52 outputs the information regarding a display position of an enlargedly displayed key as a center among all enlargedly displayed keys output from the keyboard application 40, to the key image combining unit 53.

The key image combining unit 53 as a display control unit combines the screen data of the QWERTY type software keyboard output from the key image generation unit 51 with the image data of the enlargedly displayed key output from the enlarged key image generation unit 52, and displays the combined screen data at a predetermined position on the screen DP of the screen display unit 50 on the basis of the information regarding the display position of the enlargedly displayed key as a center among the enlargedly displayed keys output from the enlarged key image generation unit 52. The predetermined position is a predetermined position based on the display position of the enlargedly displayed key as a center, output from the enlarged key image generation unit 52. In addition, in a case where image data of an enlargedly displayed key is not input from the enlarged key image generation unit 52, the key image combining unit 53 displays the screen data of the QWERTY type software keyboard output from the key image generation unit 51 on the screen DP of the screen display unit 50 as it is.

Further, in a case where the combined screen data is displayed on the screen DP of the screen display unit 50, the key image combining unit 53 temporarily stores information indicating that the enlargedly displayed key is currently being displayed on the screen DP, in a random access memory (RAM) (not illustrated) built into the portable terminal 1. This information is referred to by, for example, the key position/finger position determination unit 30.

### Operation of Portable Terminal 1 According to First Embodiment

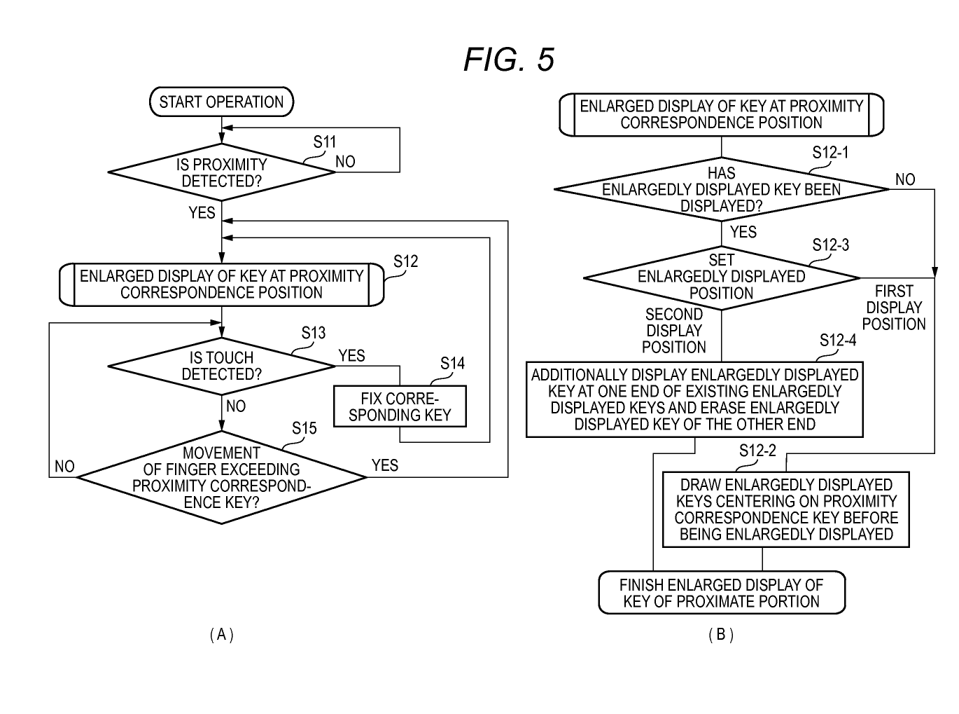

FIG. 5(A) is a flowchart illustrating an operation procedure of the portable terminal 1 according to the first embodiment. FIG. 5(B) is a flowchart illustrating an operation procedure in which a key at a proximity correspondence position is enlargedly displayed in the operation procedure illustrated in FIG. 5(A). In description of FIG. 5(A) or 5(B), the content of FIGS. 2 to 4 will be referred to as necessary.

In FIG. 5(A), the portable terminal 1 waits for the proximity detection unit 10 to detect the proximity of the finger FG to the touch panel 15 (step S11). If the proximity detection unit 10 detects the proximity of the finger FG to the touch panel 15 (YES in step S11), the proximity coordinate evaluation unit 11 calculates proximity coordinates (x, y, z) of the finger FG to the touch panel 15 on the basis of a proximity notification sent from the proximity detection unit 10. The proximity coordinate evaluation unit 11 outputs information regarding the calculated proximity coordinates (x, y, z) to the key position/finger position determination unit 30.

After step S11, an operation of the portable terminal 1 proceeds to step S12. Details of an operation in step S12 will be described later with reference to FIG. 5(B), and operations in step S13 and the subsequent steps will be described first.

After step S12, the portable terminal 1 waits for the touch detection unit 20 to detect touching (contact) of the finger FG on the touch panel 15 (step S13). If the touch detection unit 20 detects touching (contact) of the finger FG on the touch panel 15 (YES in step S13), the touch coordinate evaluation unit 21 calculates touch coordinates (x,y) of the finger FG on the touch panel 15 on the basis of a contact notification sent from the touch detection unit 20. The touch coordinate evaluation unit 21 outputs information regarding the calculated touch coordinates (x,y) to the key position/finger position determination unit 30.

The key position/finger position determination unit 30 fixes a key of the QWERTY type software keyboard displayed at a position of the touch coordinates (x,y) as a key corresponding to a user's input operation target on the basis of the information regarding the touch coordinates (x,y) output from the touch coordinate evaluation unit 21 (step S14). The key position/finger position determination unit 30 outputs information regarding the key displayed at the position of the touch coordinates (x,y) and an operation execution instruction for executing an operation (for example, a text input operation) corresponding to the key, to the keyboard application 40.

The keyboard application 40 executes an operation (for example, a text input operation) corresponding to the key fixed as a key corresponding to a user's input operation target on the basis of the operation execution instruction output from the key position/finger position determination unit 30. Then, the operation of the portable terminal 1 returns to step S12.

On the other hand, if the touch detection unit 20 does not detect touching (contact) of the finger FG on the touch panel 15 (NO in step S 13), the key position/finger position determination unit 30 causes the keyboard application 40 to determine whether or not the finger FG with which a hover operation is being performed at the proximity correspondence position is moved (a hover-slide operation) so as to exceed the proximity correspondence key, that is, the proximity coordinates (x, y, z) satisfy any one of the timings specified by the drawing change setting information 42, as illustrated in FIG. 3, on the basis of the information regarding the proximity coordinates (x, y, z) output from the proximity coordinate evaluation unit 11 (step S15). In the description of FIG. 5(A), as described with reference to FIG. 3, the drawing change setting information 42 is assumed to be information indicating the first timing. In other words, referring to FIG. 3, the drawing change setting information 42 is information indicating the timing at which the finger FG exceeds the point P1 on the boundary BR1 of the display region of the “C” key before being enlargedly displayed when the finger FG with which a hover operation is being performed on the “C” key is moved (a hover-slide operation) in the direction of the arrow RW.

If the keyboard application 40 determines that the finger FG with which a hover operation is being performed is not moved (a hover-slide operation) so as to exceed the proximity correspondence key (NO in step S15), display content of the enlargedly displayed key which is currently being displayed does not change even if there is the movement (a hover-slide operation) of the finger FG, and the operation of the portable terminal 1 returns to step S13.

On the other hand, if the keyboard application 40 determines that the finger FG with which a hover operation is being performed is moved (a hover-slide operation) so as to exceed the proximity correspondence key (YES in step S15), display content of the enlargedly displayed key which is currently being displayed changes according to the movement (a hover-slide operation) of the finger FG, and the operation of the portable terminal 1 returns to step S12.

Next, in FIG. 5(B), the key position/finger position determination unit 30 determines whether or not the enlargedly displayed key has already been displayed (step S12-1). Specifically, the key position/finger position determination unit 30 determines whether or not the enlargedly displayed key has already been displayed on the basis of whether or not information indicating that a currently enlargedly displayed key is displayed on the screen DP is stored in the RAM (not illustrated) built into the portable terminal 1.

If it is determined that the enlargedly displayed key has not already been displayed (NO in step S12-1), the key position/finger position determination unit 30 determines a proximity correspondence key which is displayed at coordinates (x,y) of the proximity correspondence position on the basis of the information regarding the proximity coordinates (x, y, z) output from the proximity coordinate evaluation unit 11 and the display key position information 31. The key position/finger position determination unit 30 determines the proximity correspondence key and then inquires of the keyboard application 40 information regarding the number of keys which are enlargedly displayed simultaneously with the determined proximity correspondence key.

The keyboard application 40 outputs, to the key position/finger position determination unit 30, information regarding the number (=four) of keys which are enlargedly displayed simultaneously with the proximity correspondence key, as response information to the inquiry from the key position/finger position determination unit 30, on the basis of the simultaneous enlargement unit setting information 41.

The key position/finger position determination unit 30 determines that the keys enlargedly displayed simultaneously with the proximity correspondence key (the “C” key) are “X”, “V”, “D” and “F” keys on the basis of the response information from the keyboard application 40 and the display key position information 31. Further, the key position/finger position determination unit 30 determines that the proximity correspondence key (the “C” key) and the keys (the “X”, “V”, “D” and “F” keys) enlargedly displayed simultaneously with the proximity correspondence key are targets generated by the enlarged key image generation unit 52. The key position/finger position determination unit 30 outputs an enlarged key image generation instruction for generating enlargedly displayed key images of the proximity correspondence key (the “C” key) and all the keys (the “X”, “V”, “D” and “F” keys) adjacent to the proximity correspondence key, to the enlarged key image generation unit 52.

Te enlarged key image generation unit 52 generates image data of enlargedly displayed keys and outputs the image data to the key image combining unit 53 on the basis of an enlarged key image generation instruction output from the key position/finger position determination unit 30. The key image combining unit 53 combines the screen data of the software keyboard output from the key image generation unit 51 with the image data of the enlargedly displayed keys output from the enlarged key image generation unit 52, and displays the combined screen data on the screen DP of the screen display unit 50 (step S12-2). In other words, the key image combining unit 53 displays the enlargedly displayed keys generated by the enlarged key image generation unit 52 on the screen DP of the screen display unit 50, centering on the display position of the proximity correspondence key (the “C” key) before being enlargedly displayed with respect to the software keyboard displayed on the screen DP of the screen display unit 50 (refer to FIG. 2).

On the other hand, if it is determined that the enlargedly displayed key has already been displayed (YES in step 512-1), the key position/finger position determination unit 30 determines a proximity correspondence key which is displayed at a proximity correspondence position of the finger FG after being moved (a hover-slide operation) on the basis of the information regarding the proximity coordinates (x, y, z) output from the proximity coordinate evaluation unit 11 and the display key position information 31.

After the proximity correspondence key is determined, the key position/finger position determination unit 30 outputs information regarding the proximity correspondence key to the keyboard application 40, and inquires of the keyboard application 40 the enlarged display position setting information 43 for specifying a display position of an enlargedly displayed key as a center when display content of enlargedly displayed keys changes according to a movement (a hover-slide operation) of the finger FG (step S12-3). In response to the inquiry from the key position/finger position determination unit 30, the keyboard application 40 refers to the enlarged display position setting information 43 and outputs, to the enlarged key image generation unit 52, information regarding the display position of the proximity correspondence key as a center when display content of enlargedly displayed keys changes according to a movement (a hover-slide operation) of the finger FG. Further, the keyboard application 40 outputs, to the key position/finger position determination unit 30, number information (=four) indicating that information regarding the number of keys which are enlargedly displayed simultaneously with the proximity correspondence key is all keys adjacent to the proximity correspondence key, as response information to the inquiry from the key position/finger position determination unit 30, on the basis of the simultaneous enlargement unit setting information 41.

In addition, the key position/finger position determination unit 30 determines that the keys enlargedly displayed simultaneously with the proximity correspondence key (the “C” key) are “X”, “V”, “D” and “F” keys on the basis of the response information from the keyboard application 40 and the display key position information 31. Further, the key position/finger position determination unit 30 determines that the proximity correspondence key (the “C” key) and the keys (the “X”, “V”, “D” and “F” keys) enlargedly displayed simultaneously with the proximity correspondence key are targets generated by the enlarged key image generation unit 52. The key position/finger position determination unit 30 outputs an enlarged key image generation instruction for generating enlargedly displayed key images of the proximity correspondence key (the “C” key) and all the keys (the “X”, “V”, “D” and “F” keys) adjacent to the proximity correspondence key, to the enlarged key image generation unit 52.

If the enlarged display position setting information 43 indicates the first display position, that is, a display position of a key before being enlargedly displayed, which is displayed at the proximity correspondence key of the finger FG after being moved (a hover-slide operation) (the first display position in step S12-3), as illustrated in the upper right part of FIG. 4, the keyboard application 40 outputs, to the enlarged key image generation unit 52, information indicating that information on a display position of an enlargedly displayed key as a center when display content of an enlargedly displayed key changes according to the movement of the finger FG is “a display position of the “V” key before being enlargedly displayed, which is displayed at the proximity correspondence position of the finger FG after being moved (a hover-slide operation)”.

The enlarged key image generation unit 52 generates image data of enlargedly displayed keys after the movement (a hover-slide operation) of the finger FG on the basis of the enlarged key image generation instruction output from the key position/finger position determination unit 30 and each of the information pieces output from the keyboard application 40, and outputs the generated image data to the key image combining unit 53. The key image combining unit 53 combines the screen data of the software keyboard output from the key image generation unit 51 with the image data of the enlargedly displayed keys output from the enlarged key image generation unit 52, and displays the combined screen data on the screen DP of the screen display unit 50. In other words, the key image combining unit 53 displays (draws) the enlargedly displayed keys generated by the enlarged key image generation unit 52 on the screen DP of the screen display unit 50, centering on the display position of the proximity correspondence key before being enlargedly displayed after the finger FG is moved, with respect to the software keyboard displayed on the screen DP of the screen display unit 50 (step S12-2).

On the other hand, if the enlarged display position setting information 43 indicates the second display position, that is, a display position with the initial display position of the enlargedly displayed key as a reference (the second display position in step S12-3), as illustrated in the lower right of FIG. 4, the keyboard application 40 outputs, to the enlarged key image generation unit 52, information indicating that information on a display position of an enlargedly displayed key as a center when display content of an enlargedly displayed key changes according to the movement of the finger FG is “an initial display position of an enlargedly displayed key (the “V” key) which is displayed at a proximity correspondence position of the finger FG after being moved (a hover-slide operation) among initial display positions of all enlargedly displayed keys which have been displayed before the movement (a hover-slide operation) of the finger FG”.

The enlarged key image generation unit 52 generates image data of enlargedly displayed keys after the movement (a hover-slide operation) of the finger FG on the basis of the enlarged key image generation instruction output from the key position/finger position determination unit 30 and each of the information pieces output from the keyboard application 40, and outputs the generated image data to the key image combining unit 53. The key image combining unit 53 combines the screen data of the software keyboard output from the key image generation unit 51 with the image data of the enlargedly displayed keys output from the enlarged key image generation unit 52, and displays the combined screen data on the screen DP of the screen display unit 50. In other words, the key image combining unit 53 additionally displays the enlargedly displayed keys of all the keys adjacent in the movement direction and erases the enlargedly displayed keys of all the keys adjacent on an opposite side to the movement direction centering on the initial display position of the proximity correspondence key of the finger FG after being moved with respect to the software keyboard displayed on the screen DP of the screen display unit 50 (step S12-4).

As mentioned above, when the proximity of the finger FG with respect to the screen DP on which the QWERTY type software keyboard is displayed, the portable terminal 1 of the present embodiment displays all keys adjacent to a proximity correspondence key in the vicinity of a proximity correspondence position, as related information or support information displayed at the proximity correspondence position which is a position on the screen corresponding to proximity coordinates of the finger FG with which a hover operation or a hover-slide operation is being performed. Consequently, the portable terminal 1 can explicitly display (draw) the support information or related information regarding the input operation target when the proximity is detected before a key as a user's input operation target is fixedly selected, so as to support a user's accurate input operation, thereby improving operability.

### Second Embodiment

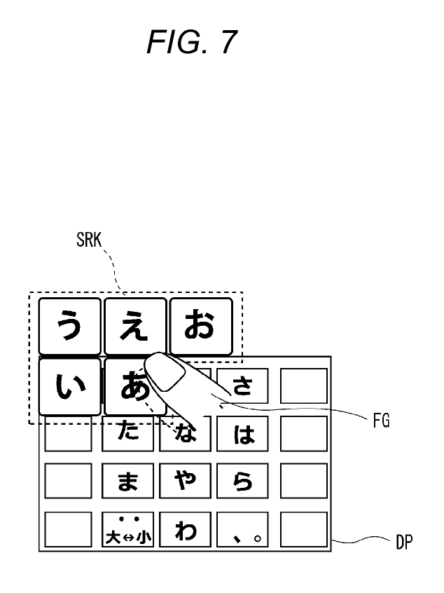

In a second embodiment, in a case where the finger approaches any one of keys of a numeric keypad type software keyboard displayed on a screen, a portable terminal 1A displays or enlargedly displays a key (for example, an “ [symbol] ” key of hiragana characters) displayed at a proximity correspondence position and related keys (for example, “ [symbol] ”, “ [symbol] ”, “ [symbol] ”, and “ [symbol] ” keys of the hiragana characters) which can be selected in a case where the key is pressed once or multiple times as related information or support information regarding an item (for example, the “ [symbol] ” key) displayed at the proximity correspondence position in the vicinity the proximity correspondence position (refer to FIG. 7).

### Functional Configuration of Portable Terminal 1A According to Second Embodiment

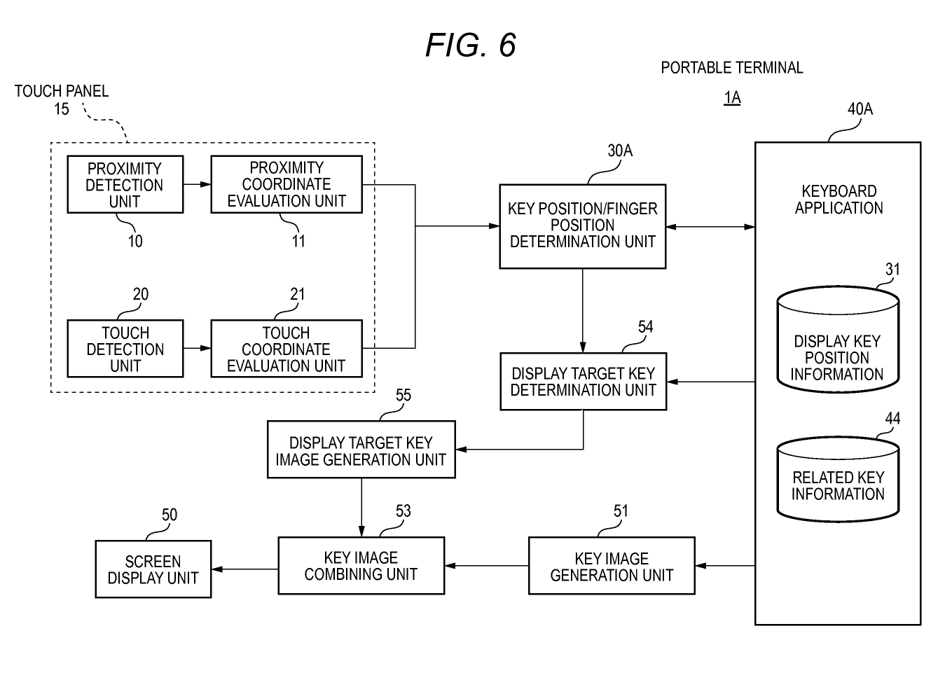

FIG. 6 is a block diagram illustrating a functional configuration of the portable terminal 1A according to the second embodiment. The same constituent elements as those of the portable terminal 1 illustrated in FIG. 1 are given the same reference numerals, description thereof will be omitted, and different content will be described.

The portable terminal 1A illustrated in FIG. 6 includes a proximity detection unit 10, a proximity coordinate evaluation unit 11, a touch detection unit 20, a touch coordinate evaluation unit 21, a key position/finger position determination unit 30A, a keyboard application 40A, a screen display unit 50, a key image generation unit 51, a key image combining unit 53, a display target key determination unit 54, and a display target key image generation unit 55. The keyboard application 40A holds display key position information 31 and related key information 44 (refer to FIG. 7). In the present embodiment, the display key position information 31 is held in the keyboard application 40A, but the content of the display key position information 31 is the same as that in the first embodiment and thus description thereof will be omitted. Further, the display key position information 31 may be held in the key position/finger position determination unit 30A in the same manner as in the first embodiment.

Each of the key position/finger position determination unit 30A, keyboard application 40A, the key image generation unit 51, the key image combining unit 53, the display target key determination unit 54, and the display target key image generation unit 55 can be operated by a processor (not illustrated) built into the portable terminal 1A reading and executing a program related to the present invention.

The key position/finger position determination unit 30A outputs information regarding proximity coordinates (x, y, z) output from the proximity coordinate evaluation unit 11, and a determination instruction for determining a key displayed at a proximity correspondence position corresponding to the proximity coordinates (x, y, z), to the keyboard application 40A. In addition, the key position/finger position determination unit 30A outputs a key displayed at a proximity correspondence position of the finger FG whose proximity is detected, and a determination instruction for determining related information regarding the key or a related key used as support information, to the display target key determination unit 54.

The keyboard application 40A as an operation execution unit is an application which is stored in advance in a ROM built into the portable terminal 1, causes the key image generation unit 51 to generate screen data of, for example, a numeric keypad type software keyboard, and receives a user's input operation (for example, a text input operation) on the numeric keypad type software keyboard displayed on the screen DP.

The keyboard application 40A determines a proximity correspondence key displayed at an x coordinate value and a y coordinate value of the proximity coordinates (x, y, z), that is, at the proximity correspondence position of the finger FG whose proximity is detected, on the basis of the information regarding the proximity coordinates (x, y, z) output from the key position/finger position determination unit 30A, the determination instruction for determining a key displayed at the proximity correspondence position corresponding to the proximity coordinates (x, y, z), and the display key position information 31.

Further, the keyboard application 40A determines related keys used as related information or support information regarding the determined proximity correspondence key on the basis of the related key information 44. FIG. 7 is a diagram illustrating a state in which an “ [symbol] ” key of hiragana characters, which is a proximity correspondence key of the finger FG, and related keys of “ [symbol] ” key of hiragana characters, are displayed. In the present embodiment, as illustrated in FIG. 7, for example, in a case where a proximity correspondence key is the “ [symbol] ” key of hiragana characters, the related keys are keys (for example, “ [symbol] ”, “ [symbol] ”, “ [symbol] ”, and “ [symbol] ” keys of the hiragana characters) which can be selected when the “ [symbol] ” key of hiragana characters is pressed once or multiple times, and are related information or support information for simplifying or making a user's text inputting efficient. The keyboard application 40A outputs information regarding each of the determined proximity correspondence key and the related keys to the display target key determination unit 54.

The display target key determination unit 54 as a display target item determination unit determines that the related keys are displayed near the proximity correspondence position corresponding to the finger FG whose proximity is detected as related information or support information regarding the proximity correspondence key on the basis of the determination instruction output from the key position/finger position determination unit 30A and the information regarding each of the proximity correspondence key and the related keys output from the keyboard application 40A. The display target key determination unit 54 outputs the information regarding the related keys and a related key image generation instruction for generating image data of the related keys, to the display target key image generation unit 55.

The display target key image generation unit 55 generates the image data of the related keys on the basis of the information regarding the related keys and the related key image generation instruction output from the display target key determination unit 54, and outputs the image data to the key image combining unit 53.

### Operation Procedure of Portable Terminal 1A of Second Embodiment

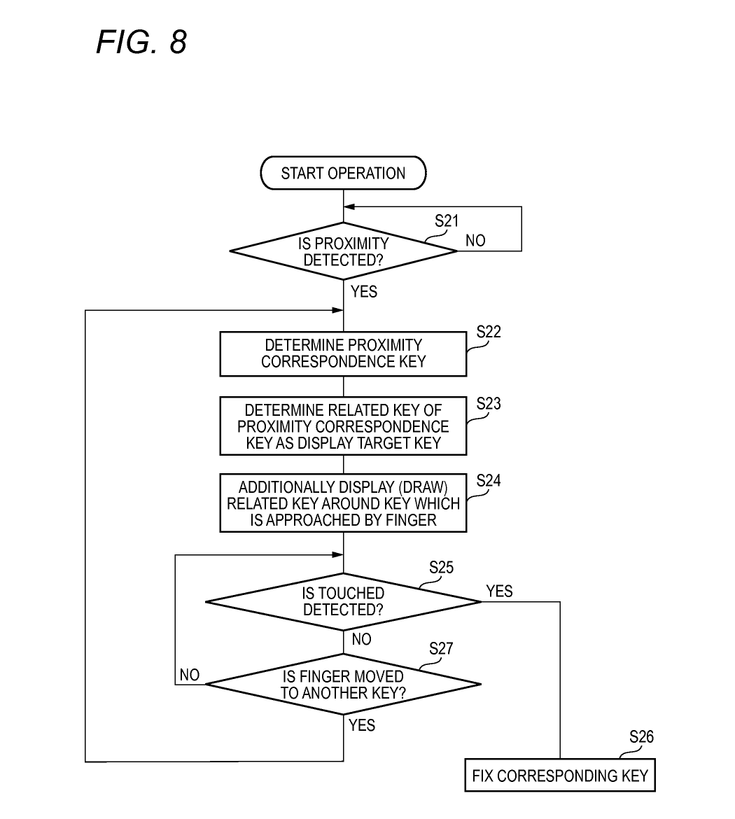

FIG. 8 is a flowchart illustrating an operation procedure of the portable terminal 1A according to the second embodiment. In description of FIG. 8, the content of FIG. 7 will be referred to as necessary.

In FIG. 8, the portable terminal 1A waits for the proximity detection unit 10 to detect the proximity of the finger FG to the touch panel 15 (step S21). If the proximity detection unit 10 detects the proximity of the finger FG to the touch panel 15 (YES in step S21), the proximity coordinate evaluation unit 11 calculates proximity coordinates (x, y, z) of the finger FG to the touch panel 15 on the basis of a proximity notification sent from the proximity detection unit 10. The proximity coordinate evaluation unit 11 outputs information regarding the calculated proximity coordinates (x, y, z) to the key position/finger position determination unit 30A.

The key position/finger position determination unit 30A outputs information regarding proximity coordinates (x, y, z) output from the proximity coordinate evaluation unit 11, and a determination instruction for determining a key displayed at a proximity correspondence position corresponding to the proximity coordinates (x, y, z), to the keyboard application 40A. In addition, the key position/finger position determination unit 30A outputs a key displayed at a proximity correspondence position of the finger FG whose proximity is detected, and a determination instruction for determining related information regarding the key or a related key used as support information, to the display target key determination unit 54.

The keyboard application 40A determines a proximity correspondence key displayed at an x coordinate value and a y coordinate value of the proximity coordinates (x, y, z), that is, at the proximity correspondence position of the finger FG whose proximity is detected, on the basis of the information regarding the proximity coordinates (x, y, z) output from the key position/finger position determination unit 30A, the determination instruction for determining a key displayed at the proximity correspondence position corresponding to the proximity coordinates (x, y, z), and the display key position information 31 (step S22).

Further, the keyboard application 40A determines related keys used as related information or support information regarding the determined proximity correspondence key on the basis of the related key information 44 (step S23). The keyboard application 40A outputs information regarding each of the determined proximity correspondence key and the related keys to the display target key determination unit 54. The display target key determination unit 54 determines that the related keys are displayed near the proximity correspondence position corresponding to the finger FG whose proximity is detected as related information or support information regarding the proximity correspondence key on the basis of the determination instruction output from the key position/finger position determination unit 30A and the information regarding each of the proximity correspondence key and the related keys output from the keyboard application 40A (step S23). The display target key determination unit 54 outputs the information regarding the related keys and a related key image generation instruction for generating image data of the related keys, to the display target key image generation unit 55.

The display target key image generation unit 55 generates the image data of the related keys on the basis of the information regarding the related keys and the related key image generation instruction output from the display target key determination unit 54, and outputs the image data to the key image combining unit 53. The key image combining unit 53 combines screen data of the numeric keypad type software keyboard output from the key image generation unit 51 with the image data of the related keys output from the display target key image generation unit 55, and displays the combined screen data on the screen DP of the screen display unit 50. In other words, the key image combining unit 53 additionally displays (draws) the related keys in the vicinity of the display position of the proximity correspondence key of the finger FG with which a hover operation is being performed on the numeric keypad type software keyboard displayed on the screen DP of the screen display unit 50, as related information or support information regarding the proximity correspondence key (step S24).

In addition, FIG. 7 illustrates an example in which the related keys (for example, “ [symbol] ”, “ [symbol] ”, “ [symbol] ”, and “ [symbol] ” keys of the hiragana characters) are displayed in the vicinity of the proximity correspondence key (the “ [symbol] ” key of the hiragana characters), but relative display positions of the related keys for the proximity correspondence key are assumed to be predefined (refer to a region SPK of FIG. 7). Further, in step S24, when the proximity correspondence key and the related keys are displayed on the screen DP of the screen display unit 50, the key image combining unit 53 may display the keys with the same magnification as that of the keys of the numeric keypad type software keyboard generated by the key image generation unit 51, and may enlargedly display the keys. FIG. 7 illustrates an example in which the keys are enlargedly displayed.

After step S24, the portable terminal 1A waits for the touch detection unit 20 to detect touching (contact) of the finger FG on the touch panel 15 (step S25). If the touch detection unit 20 detects touching (contact) of the finger FG on the touch panel 15 (YES in step S25), the touch coordinate evaluation unit 21 calculates touch coordinates (x,y) of the finger FG on the touch panel 15 on the basis of a contact notification sent from the touch detection unit 20. The touch coordinate evaluation unit 21 outputs information regarding the calculated touch coordinates (x,y) to the key position/finger position determination unit 30A.

The key position/finger position determination unit 30A fixes a key of the QWERTY type software keyboard displayed at a position of the touch coordinates (x,y) as a key corresponding to a user's input operation target on the basis of the information regarding the touch coordinates (x,y) output from the touch coordinate evaluation unit 21 (step S26). The key position/finger position determination unit 30A outputs information regarding the key displayed at the position of the touch coordinates (x,y) and an operation execution instruction for executing an operation (for example, a text input operation) corresponding to the key, to the keyboard application 40A. The keyboard application 40A executes an operation (for example, a text input operation) corresponding to the key fixed as a key corresponding to a user's input operation target on the basis of the operation execution instruction output from the key position/finger position determination unit 30A. Then, in FIG. 8, the operation of the portable terminal 1A is completed, but if the finger FG does not hover out, the operation of the portable terminal 1A may return to step S21.

On the other hand, if the touch detection unit 20 does not detect touching (contact) of the finger FG on the touch panel 15 (NO in step S25), the key position/finger position determination unit 30A determines whether or not the finger FG with which a hover operation or a hover-slide operation is being performed is moved (a hover-slide operation) to another key on the basis of the information regarding the proximity coordinates (x, y, z) output from the proximity coordinate evaluation unit 11 (step S27).

If it is determined that the finger FG with which a hover operation or a hover-slide operation is being performed is not moved (a hover-slide operation) to another key (NO in step S27), the operation of the portable terminal 1A returns to step S25.

On the other hand, if it is determined that the finger FG with which a hover operation or a hover-slide operation is being performed is moved (a hover-slide operation) to another key (YES in step S27), the operation of the portable terminal 1A returns to step S22.

As mentioned above, when detecting the proximity of the finger FG to the screen DP on which the numeric keypad type software keyboard is displayed, the portable terminal 1A displays related keys which can be selected when a proximity correspondence key is pressed once or multiple times, in the vicinity of a proximity correspondence position, as related information or support information regarding a key displayed at the proximity correspondence position which is a position on the screen corresponding to proximity coordinates of the finger FG. Consequently, the portable terminal 1A can explicitly display (draw) the support information or related information regarding the input operation target when the proximity is detected before a key as a user's input operation target is fixedly selected, so as to support a user's accurate input operation, thereby improving operability.

### Third Embodiment

In a third embodiment, a portable terminal 1B displays an operation execution item (for example, a button) which will be described later and a setting changing item (for example, a button) which will be described later in a transmissive manner with respect to a subject in order to improve a user's visibility for the subject on a preview screen of an application with a camera function.

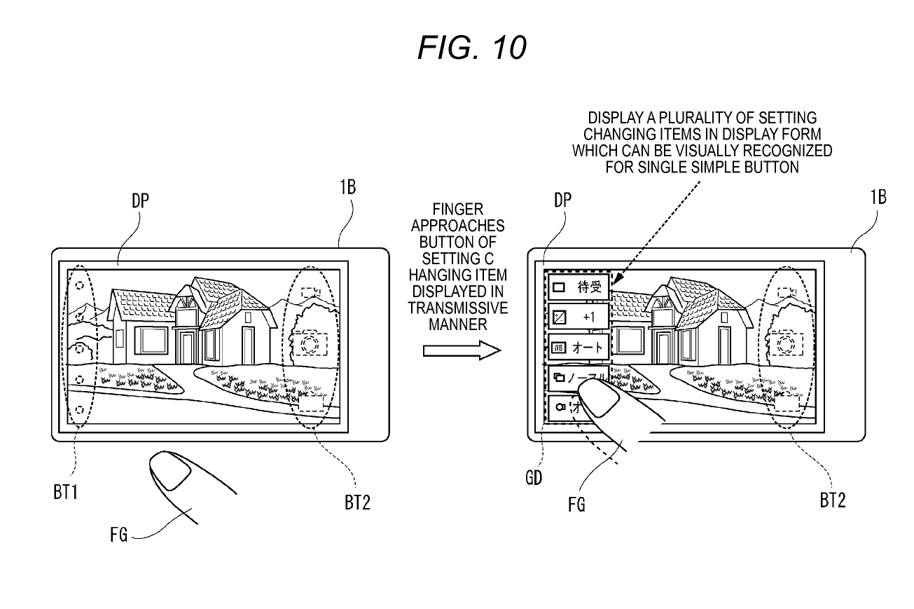

In addition, in the third embodiment, in a case where the finger approaches a “button for executing a setting changing function” which is displayed in a transmissive manner on the preview screen of the application with a camera function, the portable terminal 1B displays a plurality of setting changing items (for example, buttons) having a setting changing function in the same group corresponding to the corresponding button in a visible display form, in the vicinity of a proximity correspondence position, as related information or support information regarding the button (refer to FIG. 10). Hereinafter, in the present embodiment, a button, which simply indicates a setting changing item for executing a setting changing function and is displayed as a simple button in a transmissive manner with respect to a subject on a preview screen by the portable terminal 1B, is referred to as a “simple button”.

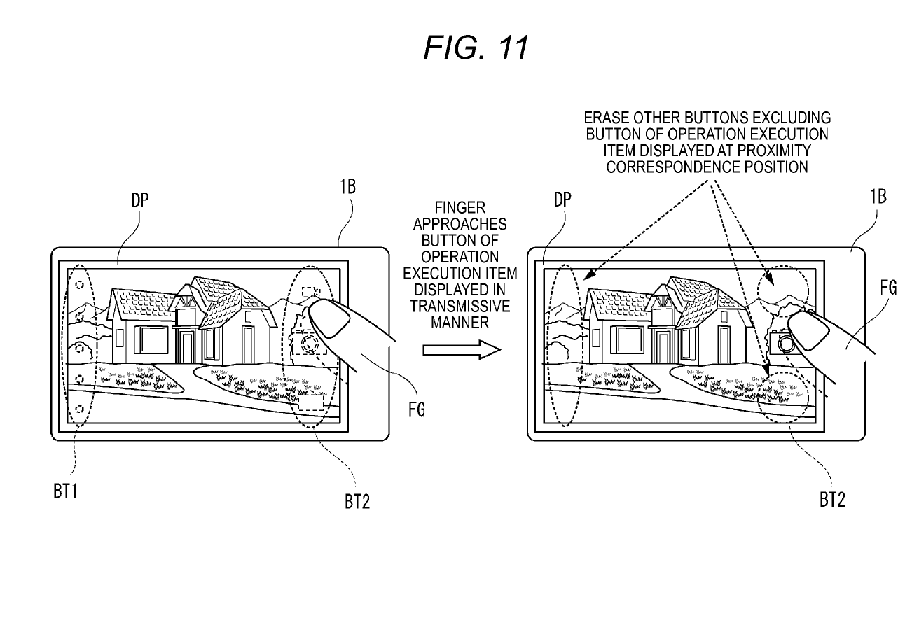

Further, in the third embodiment, in a case where the finger approaches a “button for executing an operation function” which is displayed in a transmissive manner on the preview screen of the application with a camera function, the portable terminal 1B displays a button displayed at a proximity correspondence position in a visible display form, and erases buttons other than the button displayed at the proximity correspondence position from the screen among all items (for example, buttons) displayed on the screen (refer to FIG. 11).

Still further, in the third embodiment, an item (for example, a button), which is displayed in a transmissive manner with respect to a subject on a preview screen in order to execute operation functions including an operation of capturing a still image or a moving image and an operation of viewing captured data, is defined as an “operation execution item” in the application with a camera function. Furthermore, an item (for example, a button), which is displayed in a transmissive manner with respect to a subject on a preview screen in order to execute a setting changing function including the content of setting changes which are used as various conditions for an image capturing operation, is defined as a “setting changing item” in the application with a camera function.

### Functional Configuration of Portable Terminal 1B According to Third Embodiment

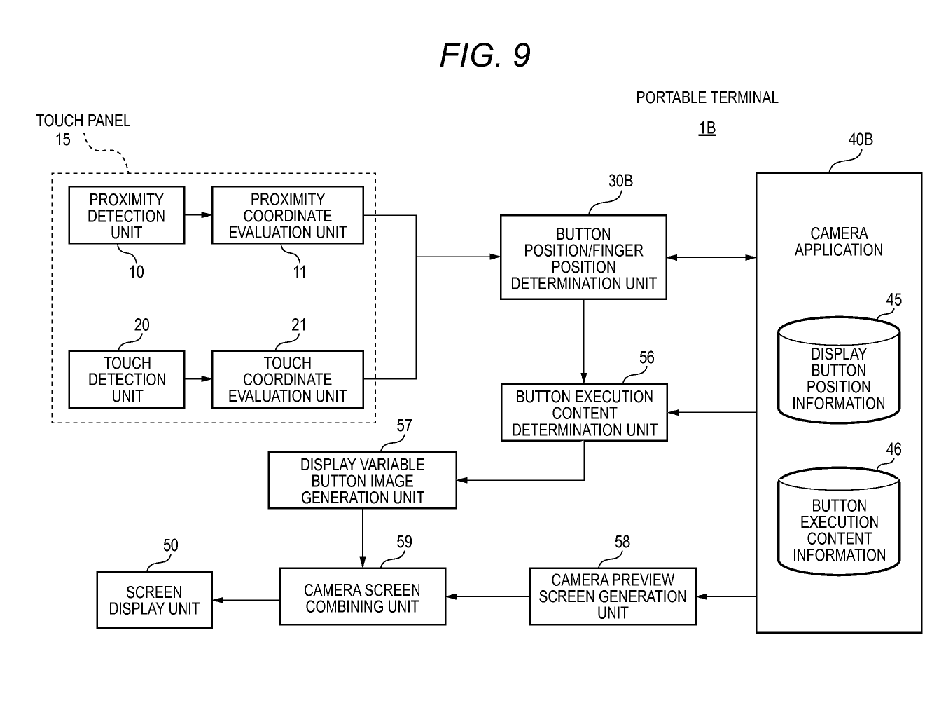

FIG. 9 is a block diagram illustrating a functional configuration of the portable terminal 1B according to the third embodiment. The same constituent elements as those of the portable terminal 1 illustrated in FIG. 1 are given the same reference numerals, description thereof will be omitted, and different content will be described.

The portable terminal 1B illustrated in FIG. 9 includes a proximity detection unit 10, a proximity coordinate evaluation unit 11, a touch detection unit 20, a touch coordinate evaluation unit 21, a button position/finger position determination unit 30B, a camera application 40B, a screen display unit 50, a button execution content determination unit 56, a display variable button image generation unit 57, a camera preview screen generation unit 58, and a camera screen combining unit 59. The camera application 40B holds display button position information 45 and button execution content information 46.

Each of the button position/finger position determination unit 30B, camera application 40B, the button execution content determination unit 56, the display variable button image generation unit 57, the camera preview screen generation unit 58, and the camera screen combining unit 59 can be operated by a processor (not illustrated) built into the portable terminal 1B reading and executing a program related to the present invention.

The button position/finger position determination unit 30B outputs information regarding proximity coordinates (x, y, z) output from the proximity coordinate evaluation unit 11, and a determination instruction for determining a button (hereinafter, referred to as a “proximity correspondence button”) displayed at a proximity correspondence position corresponding to the proximity coordinates (x, y, z), to the camera application 40B. In addition, the button position/finger position determination unit 30B outputs a determination instruction for determining whether or not a button displayed at a proximity correspondence position of the finger FG whose proximity is detected is an operation execution item or a setting changing item, to the button execution content determination unit 56.

The camera application 40B as an operation execution unit is an application which executes operation functions including an operation of capturing still image data or moving image data using a camera mechanism (not illustrated) provided in the portable terminal 1B and an operation of viewing captured data, and a setting changing function including the content of setting changes which are used as various conditions for an image capturing operation, and is stored in advance in a ROM built into the portable terminal 1B. In addition, the camera application 40B causes the camera preview screen generation unit 58 to generate screen data of a preview screen on which a subject is displayed to be checked before an image capturing operation, and receives a user's input operation (for example, an input operation for capturing a still image) on the content of the preview screen on the screen DP.

The camera application 40B determines a proximity correspondence button displayed at an x coordinate value and a y coordinate value of the proximity coordinates (x, y, z), that is, at the proximity correspondence position of the finger FG whose proximity is detected, on the basis of the information regarding the proximity coordinates (x, y, z) output from the button position/finger position determination unit 30B, the determination instruction for determining a button displayed at the proximity correspondence position corresponding to the proximity coordinates (x, y, z), and the display button position information 45.

The display button position information 45 is information for specifying a display position of each of an operation execution item and a setting changing item displayed on the preview screen generated by the camera preview screen generation unit 58. The camera application 40B determines execution content of the proximity correspondence button which is determined by using the display button position information 45, on the basis of the button execution content information 46.

The button execution content information 46 is information for specifying an operation performed in a case where each of the operation execution item and the setting changing item displayed on the preview screen generated by the camera preview screen generation unit 58 is selected through a user's touch operation, or the setting change content. The camera application 40B outputs information regarding the execution content of the proximity correspondence button determined by using the button execution content information 46, to the button execution content determination unit 56.

In addition, in the present embodiment, the button execution content information 46 is held in the camera application 40B, but may be held in the button execution content determination unit 56. In this case, the button execution content determination unit 56 obtains information regarding the proximity correspondence position from the camera application 40B, and determines execution content of the proximity correspondence button on the basis of the button execution content information 46 held in the button execution content determination unit 56.

The button execution content determination unit 56 as an item operation determination unit determines whether or not the proximity correspondence button displayed at the proximity correspondence position corresponding to the finger FG whose proximity is detected is an operation execution item or a setting changing item on the basis of the determination instruction output from the button position/finger position determination unit 30B and the information regarding the execution content of the proximity correspondence button output from the camera application 40B.

If it is determined that the proximity correspondence button is a setting changing item, the button execution content determination unit 56 outputs, to the display variable button image generation unit 57, information for displaying specific setting change content in a display form which can be visually recognized by a user as related information or support information related to a simple button which is displayed in a transmissive manner with respect to a substrate on a preview screen, and a generation instruction for generating button image data of the setting changing item in a visible display form.

If it is determined that the proximity correspondence button is an operation execution item, the button execution content determination unit 56 outputs, to the display variable button image generation unit 57, information for displaying the proximity correspondence button in a display form which can be visually recognized by the user on a preview screen, and an erasure instruction for erasing buttons (including a simple button indicating a setting changing item and operation execution items) other than the operation execution item (for example, a button) displayed at the proximity correspondence position from the screen among all items which are displayed in a transmissive manner with respect to a subject on the preview screen.

The display variable button image generation unit 57 generates button image data in which a display form of the setting changing item (simple button) displayed at the proximity correspondence position corresponding to the finger FG whose proximity is detected on the preview screen is changed from an initial transmissive display form to a display form which can be visually recognized by a user, on the basis of the information output from the button execution content determination unit 56 and the generation instruction. The display variable button image generation unit 57 outputs the generated button image data of the setting changing item to the camera screen combining unit 59.

The display variable button image generation unit 57 generates button image data in which a display form of the operation execution item displayed at the proximity correspondence position corresponding to the finger FG whose proximity is detected on the preview screen is changed from an initial transmissive display form to a display form which can be visually recognized by a user, on the basis of the information output from the button execution content determination unit 56 and the erasure instruction, and also outputs information for erasing remaining operation execution items and setting changing items (simple buttons), to the camera screen combining unit 59.

The camera preview screen generation unit 58 generates screen data of the preview screen on the basis of the generation instruction of screen data of the preview screen output from the camera application 40B. In the present embodiment, as described above, the camera preview screen generation unit 58 generates screen data so that the setting changing items and the operation execution items are in a transmissive form with respect to a subject on the preview screen. The camera preview screen generation unit 58 outputs the generated screen data to the camera screen combining unit 59.

The camera screen combining unit 59 as a display control unit combines the screen data of the preview screen output from the camera preview screen generation unit 58 with the button image data of the setting changing item output from the display variable button image generation unit 57, and displays the combined screen data on the screen DP of the screen display unit 50 (refer to FIG. 10). As illustrated in FIG. 10, the camera screen combining unit 59 displays the button image data of the setting changing items output from the display variable button image generation unit 57 in the vicinity of the display positions where the simple buttons of the setting changing items have been displayed on the screen DP.

FIG. 10 is a diagram illustrating a state in which a menu list of the same group corresponding to a simple button displayed at a proximity correspondence position is displayed in a display form which can be visually recognized by a user in a case where the finger FG approaches the simple button of the setting changing items.

A plurality of simple buttons BT1 are displayed in a transmissive display form with respect to a subject at a left end of a left preview screen of FIG. 10. In FIG. 10, as an example, five simple buttons BT1 are displayed. Each simple button is displayed in order to simply indicate the content of the setting changing item in an image capturing operation of the camera function of the portable terminal 1B. In addition, a single simple button is correlated with a plurality of setting changing items which are allocated to the simple button and are collected in the same group.

On the other hand, a plurality of buttons BT2 is displayed in a transmissive display form with respect to the subject at a right end of the left preview screen of FIG. 10. In FIG. 10, as an example, three buttons BT2 are displayed. The respective buttons are operation execution items for an image capturing operation of the camera function of the portable terminal 1B, and are a still image capturing button, a moving image capturing button, and a button for viewing a captured still image or moving image from the top of the right end of the left preview screen of FIG. 10.

In a case where the finger FG approaches any one of the simple buttons indicating the setting changing items, as illustrated in a right preview screen of FIG. 10, the portable terminal 1B displays a plurality of setting changing items GD corresponding to a simple button displayed at a proximity correspondence position corresponding to the finger FG in a display form which can be visually recognized by a user. Consequently, when the finger FG approaches a simple button which has been displayed in a simple and transmissive display form with respect to a subject on a preview screen on which the proximity of the finger FG has not been detected, the portable terminal 1B displays respective buttons of a plurality of setting changing items in a display form which can be visually recognized by a user as related information or support information regarding the simple button, and thus it is possible to improve a user's operability.

In addition, the camera screen combining unit 59 combines the screen data of the preview screen output from the camera preview screen generation unit 58 with the button image data of the operation execution item output from the display variable button image generation unit 57, and displays the combined screen data on the screen DP of the screen display unit 50.

Further, in a case where information indicating that a predetermined or more time has elapsed after the proximity of the finger FG to the proximity correspondence button which is displayed at the proximity correspondence position is acquired from a timer (not illustrated) of the portable terminal 1B, the camera screen combining unit 59 displays a screen on which the simple buttons of the remaining setting changing items and the operation execution items excluding the operation execution item displayed at the proximity correspondence position where the proximity of the finger FG is detected are erased from the screen data of the preview screen on the basis of the erasure instruction output from the display variable button image generation unit 57, on the screen DP of the screen display unit 50 (refer to FIG. 11).

FIG. 11 is a diagram illustrating a state in which the finger FG approaches the moving image capturing button which is the button of the operation execution item for a predetermined or more time. In addition, in description of FIG. 11, description of the same content as the content of FIG. 10 will be omitted, and different content will be described.

In a case where the finger FG approaches the central button (the moving image capturing button) for a predetermined or more time among the buttons BT2 indicating operation execution items, as illustrated in a right preview screen of FIG. 11, the portable terminal 1B changes a display form of the button (the moving image capturing button) corresponding to the finger FG to a display form which can be visually recognized by a user, and erases all the other buttons excluding the button (the moving image capturing button). In other words, in a case where the finger approaches the moving image capturing button for a predetermined or more time after the user changes a subject which is a target of a moving image capturing operation or settings of image capturing conditions, the user may want to capture a moving image. For this reason, the portable terminal 1B erases all buttons which are not necessary in the moving image capturing operation, and thus it is possible to improve visibility and operability when the user performs an operation related to an operation execution item for a subject.

### Operation Procedure of Portable Terminal 1B of Third Embodiment

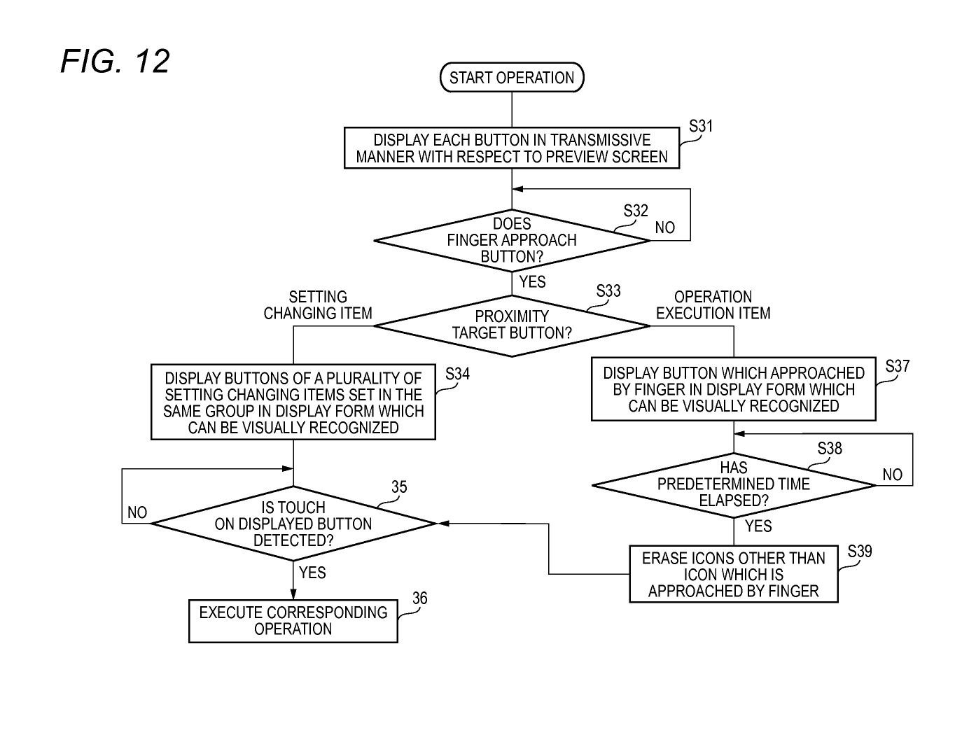

FIG. 12 is a flowchart illustrating an operation procedure of the portable terminal 1B according to the third embodiment. In description of FIG. 12, the content of FIG. 10 or 11 will be referred to as necessary.

In FIG. 12, the camera screen combining unit 59 displays a single simple button indicating a plurality of setting changing items which are collected in the same group in the camera application 40B on a preview screen of the camera application 40B in a plurality at the left end of the screen DP of the screen display unit 50, and also displays operation execution item buttons in the camera application 40B at the right end of the screen DP of the screen display unit 50 (step S3; refer to FIG. 10 or 11). In addition, a display position of each of the single simple button indicating a plurality of setting changing items and the operation execution item buttons are assumed to be predefined in the camera application 40B.

The portable terminal 1B waits for the proximity detection unit 10 to detect the proximity of the finger FG to the touch panel 15 (step S32). If the proximity detection unit 10 detects the proximity of the finger FG to the touch panel 15 (YES in step S32), the proximity coordinate evaluation unit 11 calculates proximity coordinates (x, y, z) of the finger FG to the touch panel 15 on the basis of a proximity notification sent from the proximity detection unit 10. The proximity coordinate evaluation unit 11 outputs information regarding the calculated proximity coordinates (x, y, z) to the button position/finger position determination unit 30B.

The button position/finger position determination unit 30B outputs information regarding proximity coordinates (x, y, z) output from the proximity coordinate evaluation unit 11, and a determination instruction for determining a proximity correspondence button, to the camera application 40B. In addition, the button position/finger position determination unit 30B outputs a determination instruction for determining whether or not a button displayed at a proximity correspondence position of the finger FG whose proximity is detected is an operation execution item or a setting changing item, to the button execution content determination unit 56.

The camera application 40B determines a proximity correspondence button displayed at an x coordinate value and a y coordinate value of the proximity coordinates (x, y, z), that is, at the proximity correspondence position of the finger FG whose proximity is detected, on the basis of the information regarding the proximity coordinates (x, y, z) output from the button position/finger position determination unit 30B, the determination instruction for determining a button displayed at the proximity correspondence position corresponding to the proximity coordinates (x, y, z), and the display button position information 45. The camera application 40B determines execution content of the proximity correspondence button which is determined by using the display button position information 45, on the basis of the button execution content information 46. The camera application 40B outputs information regarding the execution content of the proximity correspondence button determined by using the button execution content information 46, to the button execution content determination unit 56.

The button execution content determination unit 56 determines whether or not the proximity correspondence button displayed at the proximity correspondence position corresponding to the finger FG whose proximity is detected is an operation execution item or a setting changing item on the basis of the determination instruction output from the button position/finger position determination unit 30B and the information regarding the execution content of the proximity correspondence button output from the camera application 40B (step S33).

If it is determined that the proximity correspondence button is a setting changing item (a setting changing item in step S33), the button execution content determination unit 56 outputs, to the display variable button image generation unit 57, information for displaying specific setting change content in a display form which can be visually recognized by a user as related information or support information related to a simple button which is displayed in a transmissive manner with respect to a substrate on a preview screen, and a generation instruction for generating button image data of the setting changing item in a visible display form.

The display variable button image generation unit 57 generates button image data in which a display form of the setting changing item displayed at the proximity correspondence position corresponding to the finger FG whose proximity is detected on the preview screen is changed from an initial transmissive display form to a display form which can be visually recognized by a user, on the basis of the information output from the button execution content determination unit 56 and the generation instruction. The display variable button image generation unit 57 outputs the generated button image data of the setting changing item to the camera screen combining unit 59.

The camera screen combining unit 59 combines the screen data of the preview screen output from the camera preview screen generation unit 58 with the button image data of the setting changing item output from the display variable button image generation unit 57, and displays the combined screen data on the screen DP of the screen display unit 50 (step S34; refer to FIG. 10).

After step S34, the portable terminal 1B waits for the touch detection unit 20 to detect touching (contact) of the finger FG on the touch panel 15 (step S35). If the touch detection unit 20 detects touching (contact) of the finger FG on the touch panel 15 (YES in step S35), the button position/finger position determination unit 30B outputs the information regarding the touch coordinates (x,y) output from the touch coordinate evaluation unit 21, to the camera application 40B. The camera application 40B executes an operation corresponding to an item on the preview screen, falling under the information regarding the touch coordinates (x,y) output from the button position/finger position determination unit 30B, or the setting change content (step S36).

On the other hand, if it is determined that the proximity correspondence button is an operation execution item (an operation execution item in step S33), the button execution content determination unit 56 outputs, to the display variable button image generation unit 57, information for displaying the proximity correspondence button in a display form which can be visually recognized by the user on a preview screen, and an erasure instruction for erasing buttons (including a simple button indicating a setting changing item and operation execution items) other than the operation execution item (for example, a button) displayed at the proximity correspondence position from the screen among all items which are displayed in a transmissive manner with respect to a subject on the preview screen.

The display variable button image generation unit 57 generates button image data in which a display form of the setting changing item (simple button) displayed at the proximity correspondence position corresponding to the finger FG whose proximity is detected on the preview screen is changed from an initial transmissive display form to a display form which can be visually recognized by a user, on the basis of the information output from the button execution content determination unit 56 and the generation instruction, and also outputs information for erasing remaining operation execution items and setting changing items to the camera screen combining unit 59.

The camera screen combining unit 59 combines the screen data of the preview screen output from the camera preview screen generation unit 58 with the button image data of the operation execution item output from the display variable button image generation unit 57, and displays the combined screen data on the screen DP of the screen display unit 50 (step S37).

Further, in a case where information indicating that a predetermined or more time has elapsed after the proximity of the finger FG to the proximity correspondence button which is displayed at the proximity correspondence position is acquired from a timer (not illustrated) of the portable terminal 1B (YES in step S38), the camera screen combining unit 59 displays a screen on which the simple buttons of the remaining setting changing items and the operation execution items excluding the operation execution item displayed at the proximity correspondence position where the proximity of the finger FG is detected are erased from the screen data of the preview screen on the basis of the erasure instruction output from the display variable button image generation unit 57, on the screen DP of the screen display unit 50 (step S39; refer to FIG. 11). After step S39, an operation of the portable terminal 1B returns to step S35, and thus description of the subsequent operations will be omitted.

As mentioned above, in a case where the finger FG approaches a simple button indicating a plurality of setting changing items which are displayed in a transmissive manner and are set in the same group on a preview screen of the application (the camera application 40B) with the camera function, the portable terminal 1B of the present embodiment displays a plurality of setting changing items corresponding to each simple button from a transmissive display form to a display form which can be visually recognized by a user (refer to FIG. 10). Consequently, the portable terminal 1B displays the content of a plurality of setting changing items indicated by the proximity correspondence button in a display form which can be visually recognized by a user as related information or support information regarding the simple button (proximity correspondence button) to which the proximity of the finger FG is detected, and thus it is possible to improve a user's operability.

In addition, in a case where the finger FG approaches a button indicating each operation execution item which is displayed in a transmissive manner on a preview screen of the application (the camera application 40B) with the camera function, the portable terminal 1B displays a proximity correspondence button from a transmissive display form to a display form which can be visually recognized by a user, and also erases the display of respective buttons of remaining items (the operation execution items and simple buttons of the setting changing items) in a case where the proximity of the finger FG to the same proximity correspondence button is continuously performed for a predetermined or more time. Consequently, for example, in a case where the finger FG approaches a moving image capturing button for a predetermined or more time, the portable terminal 1B erases all buttons which are not necessary in the moving image capturing operation, and thus it is possible to improve visibility and operability when a user performs an operation related to an operation execution item for a subject.

### Fourth Embodiment

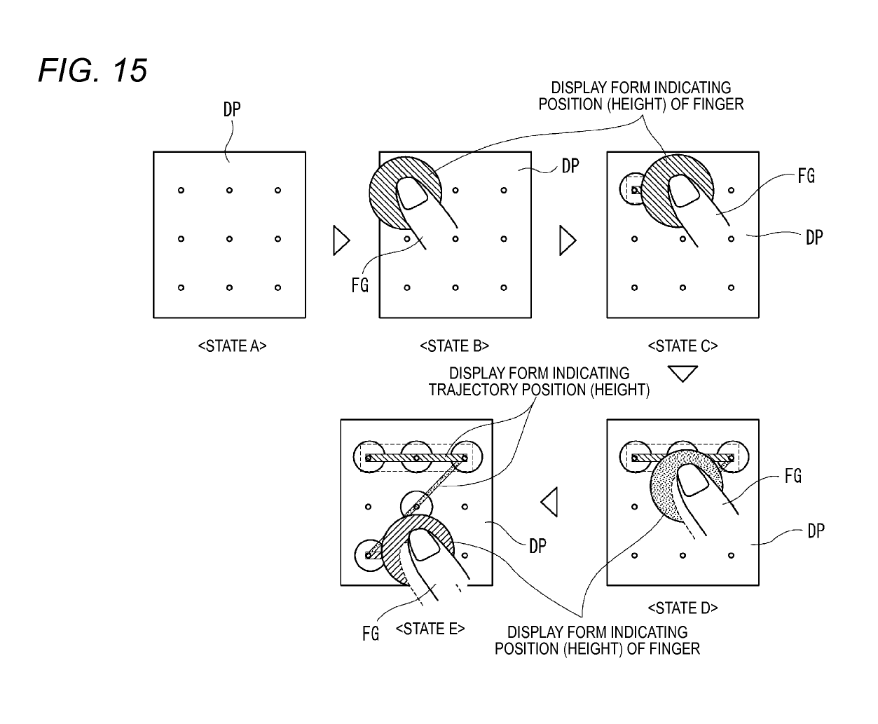

In a fourth embodiment, a portable terminal 1C displays an image of a trajectory of a cancellation operation and a detection region of the proximity or contact in the image of the trajectory in an identifiable display form as related information or support information for a user cancelling a security lock or supporting the cancellation operation, on a security lock screen displayed in a security lock (for example, a screen lock) function which is activated when an input operation is not performed from the user for a predetermined or more time (refer to FIG. 15).

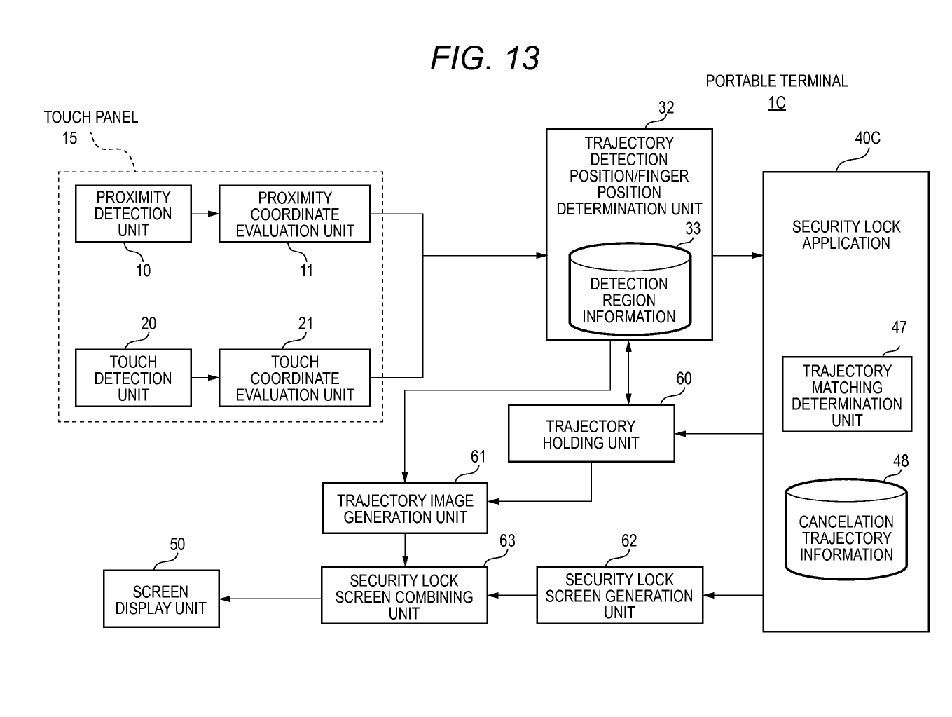

FIG. 13 is a block diagram illustrating a functional configuration of the portable terminal 1C according to the fourth embodiment. The same constituent elements as those of the portable terminal 1 illustrated in FIG. 1 are given the same reference numerals, description thereof will be omitted, and different content will be described.

The portable terminal 1C illustrated in FIG. 13 includes a proximity detection unit 10, a proximity coordinate evaluation unit 11, a touch detection unit 20, a touch coordinate evaluation unit 21, a trajectory detection position/finger position determination unit 32, a security lock application 40C, a screen display unit 50, a trajectory holding unit 60, a trajectory image generation unit 61, a security lock screen generation unit 62, and a security lock screen combining unit 63. The trajectory detection position/finger position determination unit 32 holds detection region information 33. The security lock application 40C includes a trajectory matching determination unit 47, and holds cancelation trajectory information 48.

Each of the trajectory detection position/finger position determination unit 32, the security lock application 40C, the trajectory matching determination unit 47, the trajectory image generation unit 61, the security lock screen generation unit 62, and the security lock screen combining unit 63 can be operated by a processor (not illustrated) built into the portable terminal 1C reading and executing a program related to the present invention.

The trajectory detection position/finger position determination unit 32 as a trajectory position determination unit determines a trajectory position of a cancellation operation using the finger FG on a security lock screen and a detection region through which the finger FG is passing on the basis of information regarding proximity coordinates (x, y, z) output from the proximity coordinate evaluation unit 11 or touch coordinates (x,y) output from the touch coordinate evaluation unit 21, and the detection region information 33. The trajectory detection position/finger position determination unit 32 outputs information regarding the determined trajectory position of the cancellation operation using the finger FG to the security lock application 40C, and temporarily stores the determined trajectory position of the cancellation operation using the finger FG and information regarding a detection region through which the finger FG is passing in the trajectory holding unit 60 in correlation with each other.

The detection region information 33 is information indicating a relationship between a trajectory position of a cancellation operation using the finger FG on a security lock screen and a predefined detection region. The detection region information 33 will be described with reference to FIGS. 14(A) to 14(C). FIG. 14(A) is a diagram illustrating a security lock screen and nine detection points provided in the touch panel 15. FIG. 14(B) is a conceptual diagram illustrating a touch detection region, a low hovering detection region, and a high hovering detection region. FIG. 14(C) is a diagram illustrating detection points provided in the respective regions and a trajectory of the finger FG.

As illustrated in FIG. 14(A), in the touch panel 15 of the portable terminal 1C, for example, a total of nine detection points DT1 to DT9 in which gaps between the respective detection points are predefined values and are the same as each other are provided on the security lock screen displayed on the screen DP. In addition, positions of the detection points may not be specified so that a gap in a vertical direction between the adjacent detection points is the same as a gap in a horizontal direction between the detection points, and, for example, a gap in the vertical direction between the adjacent detection points may have a value different from a value of a gap in the horizontal direction therebetween.

Further, in the touch panel 15 of the portable terminal 1C, a total of nine detection points DT1 to DT9 illustrated in FIG. 14(A) are provided in the touch detection region (refer to a reversely hatched portion) illustrated in FIG. 14(B), the low hovering detection region (referred to a dot pattern portion) as a first space proximity detection region, and the high hovering detection region (referred to a hatched portion) as a second space proximity detection region, respectively, and thus a total of twenty-seven detection points DT1 to DT27 (refer to FIG. 14(C)).

In other words, a total of nine detection points DT1 to DT9 are provided in the touch detection region, a total of nine detection points DT10 to DT18 are provided in the low hovering detection region, and a total of nine detection points DT19 to DT27 are provided in the high hovering detection region. The trajectory detection position/finger position determination unit 32 determines through which detection points the finger FG with which a cancellation operation is being performed has passed among the total of twenty-seven detection points DT1 to DT27. In addition, the touch detection region is provided at a position where a height in the z axis direction is 0 (zero), the low hovering detection region is provided at a position where a height in the z axis direction is between 0 (zero) and z1, and the high hovering detection region is provided at a position where a height in the z axis direction is provided between z1 and z2.

Further, the trajectory detection position/finger position determination unit 32 refers to the trajectory holding unit 60, and outputs, to the trajectory image generation unit 61, information for generating a trajectory image including a trajectory (for example, a straight line or a curve) for a cancellation operation using the finger FG and a detection region where the trajectory of the cancellation operation using the finger FG is passing.

The security lock application 40C as an operation execution unit is an application which is stored in advance in a ROM built into the portable terminal 1C, and is used to lock a user's use of the portable terminal 1C in a case where an input operation is not performed on the portable terminal 1C for a predetermined or more time. The security lock application 40C causes the security lock screen generation unit 62 to generate a security lock screen on the basis of a certain input operation (for example, pressing of a power supply button or a predetermined home button) in a stop state of the portable terminal 1C due to the user not performing an input operation for a predetermined or more time, and receives a cancellation operation on the security lock screen on the screen DP of the screen display unit 50 from the user.

In a case where the security lock application 40C acquires information regarding a trajectory position output from the trajectory detection position/finger position determination unit 32, and information indicating that the finger FG hovers out is output from the trajectory detection position/finger position determination unit 32, the trajectory matching determination unit 47 compares the information regarding the trajectory position output from the trajectory detection position/finger position determination unit 32 up to the hovering-out with the cancelation trajectory information 48.

In addition, the trajectory matching determination unit 47 temporarily stores information regarding a comparison result, the information regarding the trajectory position of a cancellation operation using the finger FG stored in the trajectory holding unit 60 by the trajectory detection position/finger position determination unit 32, and information regarding the detection region through which the finger FG is passing, in the trajectory holding unit 60 in correlation with each other. If the information regarding the trajectory position output from the trajectory detection position/finger position determination unit 32 matches the cancelation trajectory information 48 up to the hovering-out, the trajectory matching determination unit 47 outputs information for canceling the security lock to the security lock application 40C.

The cancelation trajectory information 48 is trajectory information of a cancellation operation which is registered in advance in order to enable a user's input operation on the portable terminal 1C by canceling a security lock screen when the security lock screen is displayed. The cancelation trajectory information 48 may be changed as appropriate through a user's setting changing operation.

The trajectory holding unit 60 is configured by using a RAM built into the portable terminal 1C, and temporarily stores information regarding a trajectory position of a cancellation operation using the finger FG output from the trajectory detection position/finger position determination unit 32 and information regarding a detection region through which the finger FG is passing in correlation with each other. In addition, the trajectory holding unit 60 temporarily stores a component result from the trajectory matching determination unit 47, information regarding a trajectory position of a cancellation operation using the finger FG, and information regarding a detection region through which the finger FG is passing in correlation with each other.

The trajectory image generation unit 61 generates trajectory image data including a trajectory (for example, a straight line or a curve) for a cancellation operation using the finger FG and a detection region through which the trajectory of the cancellation operation using the finger FG is passing, by referring to the trajectory holding unit 60, on the basis of the information output from the trajectory detection position/finger position determination unit 32, and outputs the trajectory image data to the security lock screen combining unit 63. The trajectory image data will be described later with reference to FIG. 15.

The security lock screen generation unit 62 generates screen data of a security lock screen on the basis of a generation instruction of the security lock screen output from the security lock application 40C. The security lock screen generation unit 62 outputs the generated screen data to the security lock screen combining unit 63.

The security lock screen combining unit 63 as a display control unit combines the screen data of the security lock screen output from the security lock screen generation unit 62 with the trajectory image data output from the trajectory image generation unit 61, and displays the combined screen data on the screen DP of the screen display unit 50 (refer to FIG. 15). The security lock screen combining unit 63 explicitly displays a trajectory and a trajectory position (a detection region) from the start of the cancellation operation using the finger FG on the screen DP by using the trajectory image data output from the trajectory image generation unit 61.

Next, with reference to FIG. 15, a description will be made of trajectory image data indicating a trajectory position and a detection region (a height of the trajectory position) where a trajectory is passing in a cancellation operation using the finger FG according to the present embodiment. FIG. 15 is a diagram illustrating a display form of a trajectory of a cancellation operation using the finger FG with respect to a security lock screen and a display form of a trajectory position (height). FIG. 15 sequentially illustrates five states including a state A, a state B, a state C, a state D, and a state E as states in which a cancellation operation is input.

The state A is a state in which a cancellation operation using the finger FG has not yet been input. The state B indicates a state in which the detection point DT7 (refer to FIG. 14(A)) of the touch detection region is first touched with the finger FG. The trajectory image generation unit 61 generates image data of a display form (for example, a translucent red circular form; refer to a reversely hatched portion in FIG. 15) indicating a height (a detection region) of the trajectory position of the finger FG as trajectory image data corresponding to the state B. Therefore, in the state B, the portable terminal 1C displays image data of the translucent red circular form (refer to the reversely hatched portion in FIG. 15) on a security lock screen as image data indicating that the height of the trajectory position of the finger FG is the touch detection region.

Next, the state C indicates a state in which the finger FG passes through the detection point DT8 (refer to FIG. 14(A)) while staying at the position of the touch detection region. The trajectory image generation unit 61 generates image data of a display form (for example, a translucent red circular form; refer to a reversely hatched portion in FIG. 15) indicating a height (a detection region) of the trajectory position of the finger FG as trajectory image data corresponding to the state C, and also generates linear image data indicating the trajectory of the finger FG by using red (refer to the reversely hatched portion in FIG. 15) which is the same as the color of the display form indicating the height (a detection region) of the trajectory position of the finger FG. Therefore, in the state C, the portable terminal 1C displays image data of the translucent red circular form (refer to the reversely hatched portion in FIG. 15) on the security lock screen as image data indicating that the height of the trajectory position of the finger FG is the touch detection region. In addition, the portable terminal 1C displays the linear image data indicating the trajectory of the finger FG on the security lock screen by using red (refer to the reversely hatched portion in FIG. 15) which is the same as the color of the display form indicating the height (a detection region) of the trajectory position of the finger FG.

Next, the state D indicates a state right before the finger FG passes through the central detection point of the low hovering detection region at the position of the low hovering detection region. The trajectory image generation unit 61 generates image data of a display form (for example, a translucent green circular form; refer to a dot pattern portion in FIG. 15) indicating a height (a detection region) of the trajectory position of the finger FG as trajectory image data corresponding to the state D, and also generates linear image data indicating the trajectory of the finger FG by using green (refer to the dot pattern portion in FIG. 15) which is the same as the color of the display form indicating the height (a detection region) of the trajectory position of the finger FG. Therefore, in the state D, the portable terminal 1C displays image data of the translucent green circular form (refer to the dot pattern portion in FIG. 15) on the security lock screen as image data indicating that the height of the trajectory position of the finger FG is the low hovering detection region. In addition, the portable terminal 1C displays the linear image data indicating the trajectory of the finger FG on the security lock screen by using green (refer to the dot pattern portion in FIG. 15) which is the same as the color of the display form indicating the height (a detection region) of the trajectory position of the finger FG.

Finally, the state E indicates a state right after the finger FG passes through the central detection point of the high hovering detection region at the position of the high hovering detection region. The trajectory image generation unit 61 generates image data of a display form (for example, a translucent yellow circular form; refer to a hatched portion in FIG. 15) indicating a height (a detection region) of the trajectory position of the finger FG as trajectory image data corresponding to the state E, and also generates linear image data indicating the trajectory of the finger FG by using yellow (refer to the hatched portion in FIG. 15) which is the same as the color of the display form indicating the height (a detection region) of the trajectory position of the finger FG. Therefore, in the state E, the portable terminal 1C displays image data of the translucent yellow circular form (refer to the dot pattern portion in FIG. 15) on the security lock screen as image data indicating that the height of the trajectory position of the finger FG is the high hovering detection region. In addition, the portable terminal 1C displays the linear image data indicating the trajectory of the finger FG on the security lock screen by using yellow (refer to the hatched portion in FIG. 15) which is the same as the color of the display form indicating the height (a detection region) of the trajectory position of the finger FG.

As mentioned above, the portable terminal 1C displays a height (a detection region) of a trajectory position of the finger FG and a trajectory in which the finger FG passes through the height of the trajectory position, for example, in a display form of the same color or the same pattern, as related information or support information regarding a position (a proximity correspondence position or a touch position) which the finger FG approaches or comes into contact with among positions of predetermined detection points, between starting and ending of a cancellation operation using the finger FG with respect to the security lock screen. Consequently, the portable terminal 1C can simply display a trajectory (for example, a straight line or a curve) drawn by the finger FG in a cancellation operation and a detection region which the trajectory is currently passing or passed previously in correlation with each other. Therefore, the portable terminal 1C enables a user to visually compare and confirm the cancelation trajectory information 48 memorized by the user with a cancellation operation which is currently being performed and also enables to the user to easily perform the cancellation operation of a security lock screen.

### Operation Procedure of Portable Terminal 1C of Fourth Embodiment

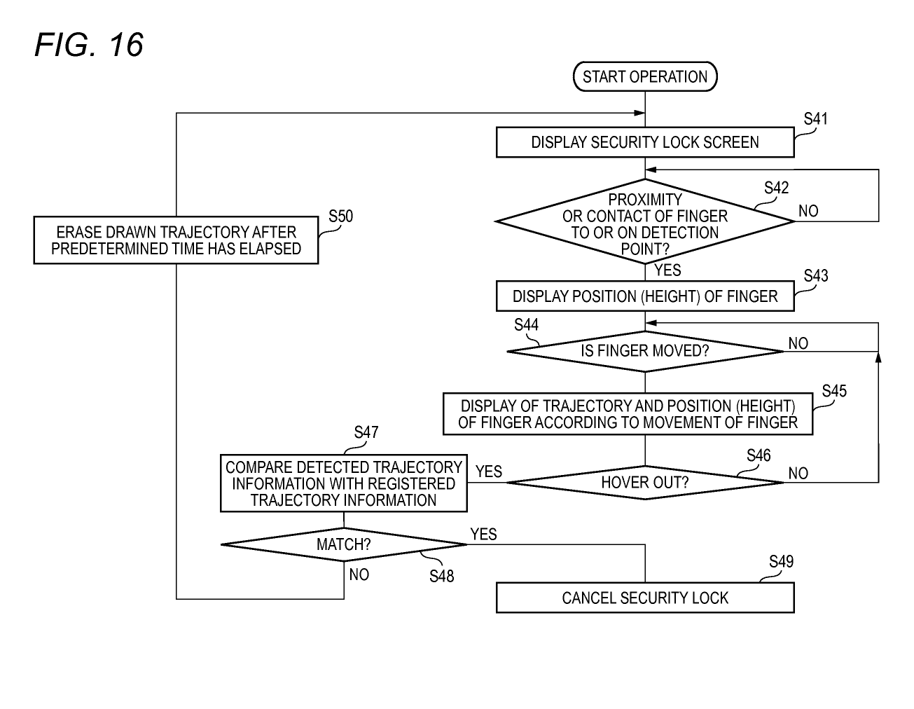

FIG. 16 is a flowchart illustrating an operation procedure of the portable terminal 1C according to the fourth embodiment. In description of FIG. 16, the content of FIG. 14 or 15 will be referred to as necessary.

In FIG. 16, the security lock screen combining unit 63 displays screen data of a security lock screen generated by the security lock screen generation unit 62 on the screen DP of the screen display unit 50 (step S41). The portable terminal 1C waits for either the proximity detection unit 10 to detect the proximity of the finger FG to the touch panel 15 or the touch detection unit 20 to detect a touch of the finger FG on the touch panel 15 (step S42).

If either the proximity detection unit 10 detects the proximity of the finger FG to the touch panel 15 or the touch detection unit 20 detects a touch of the finger FG on the touch panel 15 (YES in step S42), the trajectory detection position/finger position determination unit 32 determines a trajectory position of a cancellation operation using the finger FG on the security lock screen and a detection region through which the finger FG is passing on the basis of proximity coordinates (x, y, z) output from the proximity coordinate evaluation unit 11 or touch coordinates (x,y) output from the touch coordinate evaluation unit 21 and the detection region information 33. The trajectory detection position/finger position determination unit 32 outputs information regarding the determined trajectory position of the cancellation operation using the finger FG to the security lock application 40C, and also temporarily stores the information regarding the determined trajectory position of the cancellation operation using the finger FG and information regarding the detection region through which the finger FG is passing in the trajectory holding unit 60 in correlation with each other. In addition, the trajectory detection position/finger position determination unit 32 refers to the trajectory holding unit 60, and outputs, to the trajectory image generation unit 61, information for generating a trajectory image including a trajectory (for example, a straight line or a curve) for a cancellation operation using the finger FG and a detection region where the trajectory of the cancellation operation using the finger FG is passing.

The trajectory image generation unit 61 generates trajectory image data including a trajectory (for example, a straight line or a curve) for a cancellation operation using the finger FG and a detection region through which the trajectory of the cancellation operation using the finger FG is passing, by referring to the trajectory holding unit 60, on the basis of the information output from the trajectory detection position/finger position determination unit 32, and outputs the trajectory image data to the security lock screen combining unit 63.

The security lock screen combining unit 63 combines the screen data of the security lock screen output from the security lock screen generation unit 62 with the trajectory image data output from the trajectory image generation unit 61, and displays the combined screen data on the screen DP of the screen display unit 50 (refer to FIG. 15). In other words, the security lock screen combining unit 63 displays trajectory image data indicating a trajectory position and a detection region (a height of the trajectory position) through which the trajectory is passing in the cancellation operation using the finger FG on the security lock screen according to a position (a height) of the finger FG (step S43; referred to the state B of FIG. 15).

After step S43, if there is a movement (a hover-slide operation or a touch-slide operation) of the finger FG with which a hover operation or a touch operation is being performed (YES in step S44), in the same manner as in step S43, the security lock screen combining unit 63 displays trajectory image data indicating a trajectory position and a detection region (a height of the trajectory position) through which the trajectory is passing in the cancellation operation using the finger FG on the security lock screen according to the movement (a hover-slide operation or a touch-slide operation) of the finger FG (step S45; referred to the state C, the state D, and the state E of FIG. 15)

After step S45, if the finger FG does not hover out (NO in step S46), the operation of the portable terminal 1C returns to step S44. On the other hand, after step S45, if the finger FG hovers out (YES in step S46), the trajectory matching determination unit 47 compares a trajectory of the cancellation operation using the finger FG, detected up to the hovering-out with the cancelation trajectory information 48 (step S47).

If the trajectory of the cancellation operation using the finger FG, detected up to the hovering-out matches the cancelation trajectory information 48 (YES in step S47), the trajectory matching determination unit 47 outputs information for canceling the security lock to the security lock application 40C. The security lock application 40C cancels the security lock screen displayed on the screen DP of the screen display unit 50 on the basis of the information output from the trajectory matching determination unit 47 (step S49), and switches a state of the portable terminal 1C to a state in which an input operation can be received from a user.

On the other hand, if the trajectory of the cancellation operation using the finger FG, detected up to the hovering-out does not match the cancelation trajectory information 48 (NO in step S47), the trajectory matching determination unit 47 erases the trajectory of the cancellation operation using the finger FG after a predetermined time has elapsed from the component time point in step S47 (step S50). After step S50, the operation of the portable terminal 1C returns to step S41.

As mentioned above, the portable terminal 1C displays a height (a detection region) of a trajectory position of the finger FG and a trajectory in which the finger FG passes through the height of the trajectory position, for example, in a display form of the same color or the same pattern, as related information or support information regarding a position which the finger FG approaches or comes into contact with among positions of predetermined detection points, between starting and ending of a cancellation operation using the finger FG with respect to the security lock screen, under the condition in which the finger FG does not hover out.

Consequently, the portable terminal 1C can simply display a trajectory (for example, a straight line or a curve) drawn by the finger FG in a cancellation operation and a detection region which the trajectory is currently passing or passed previously in correlation with each other. Therefore, the portable terminal 1C enables a user to visually compare and confirm the cancelation trajectory information 48 memorized by the user with a cancellation operation which is currently being performed and also enables to the user to easily perform the cancellation operation of a security lock screen.

As mentioned above, although the various embodiments have been described with reference to the drawings, it is needless to say that the present invention is not limited to the embodiments. It is obvious that a person skilled in the art can conceive of alterations or modifications of the various embodiments and combinations of the various embodiments within the scope recited in the claims, and it is understood that they naturally fall within the technical scope of the present invention.

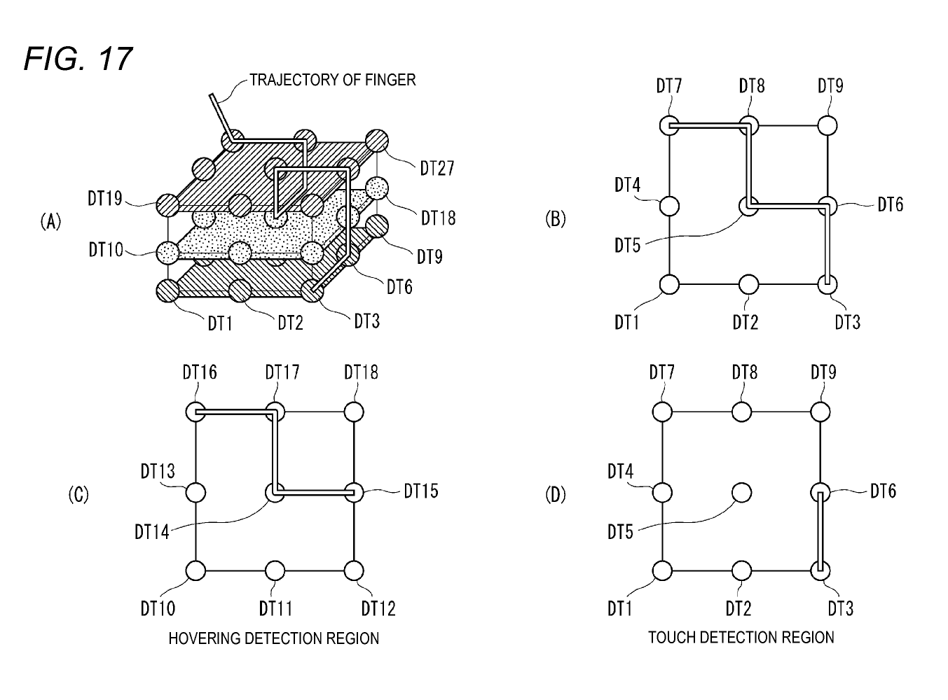

In addition, in the fourth embodiment, a description has been made of a case where the trajectory detection position/finger position determination unit 32 uses the respective nine detection points specified for each layer of the three detection regions (the touch detection region, the low hovering detection region, and the high hovering detection region) illustrated in FIG. 14(B) in determination of matching of a trajectory of the finger FG as different detection points in the z axis direction. Further, the trajectory detection position/finger position determination unit 32 may regard a total of two or three detection points in the z axis direction in, for example, two layers (the low hovering detection region and the high hovering detection region) of the three detection region layers or all the layers, as a single detection point, so that the operation of determining matching of a trajectory of the finger FG is simplified (refer to FIG. 17).

FIG. 17 is a diagram illustrating a screen display example of an input trajectory of the finger FG in a case where a total of two or three detection points in the z axis direction of the touch detection region, the low hovering detection region, and the high hovering detection region are regarded as a single detection point. FIG. 17(A) is a diagram illustrating detection points provided in the respective detection regions and a trajectory of the finger. FIG. 17(B) illustrates a screen display example of a trajectory of the finger

FG (refer to FIG. 17(A)) in a case where three detection points in the z axis direction of all the detection regions are regarded as a single detection point. FIG. 17(C) illustrates a screen display example of a trajectory of the finger FG (refer to FIG. 17(A)) in a case where two detection points in the z axis direction of the low hovering detection region and the high hovering detection region are regarded as a single detection point. FIG. 17(D) illustrates a screen display example of a trajectory of the finger FG (refer to FIG. 17(A)) in the touch detection region.

In FIG. 17(B), the trajectory detection position/finger position determination unit 32 regards, as a single detection point, three detection points of which x coordinate values and y coordinate values are the same as each other, and z coordinate values are different from each other, among the respective nine detection points of each of the three detection region layers (the touch detection region, the low hovering detection region, and the high hovering detection region) illustrated in FIG. 17(A). For example, FIG. 17(B) illustrates a state in which the detection points DT1, DT10 and DT19 are regarded as the same detection point (for example, DT1), and the trajectory of the finger FG illustrated in FIG. 17(A) passes through the detection points DT7, DT8, DT5, DT6 and DT3.

In FIG. 17(C), the trajectory detection position/finger position determination unit 32 regards, as a single detection point, two detection points of which x coordinate values and y coordinate values are the same as each other, and z coordinate values are different from each other, among the respective nine detection points of each of the two detection region layers (the low hovering detection region and the high hovering detection region) illustrated in FIG. 17(A). For example, FIG. 17(C) illustrates a state in which the detection points DT10 and DT19 are regarded as the same detection point, and the trajectory of the finger FG illustrated in FIG. 17(A) passes through the detection points DT16, DT17, DT14 and DT15.

In addition, the trajectory detection position/finger position determination unit 32 identifies that a total of nine detection points of the touch detection region illustrated in FIG. 17(A) are different from a total of nine detection points as a result of regarding the detection points in the z axis direction of a total of eighteen detection points of the low hovering detection region and the high hovering detection region illustrated in the same figure as the same detection points. For example, FIG. 17(D) illustrates a state in which the trajectory of the finger FG illustrated in FIG. 17(A) passes through the detection points DT6 and DT3 of the touch detection region so as to follow the screen display example of the trajectory of the finger FG illustrated in FIG. 17(C). Consequently, in consideration of a case where it is hard to more stably perform a user's hover operation or hover-slide operation than a touch operation or a touch-slide operation, the portable terminal 1C can simplify a lock cancelation operation on a security lock screen in accordance with accuracy of a hover operation or a hover-slide operation which can be performed by the user or the user's preference.

This application is based on Japanese Patent Application No. 2012-217711 filed on Sep. 28, 2012, the contents of which are incorporated herein by reference.

### INDUSTRIAL APPLICABILITY

The present invention is useful for a display control device, a display control method, and a program, which explicitly display support information or related information regarding an input operation target when the proximity is detected before a user selects and fixes the input operation target, so as to support a user's accurate input operation, thereby improving operability.

### REFERENCE SIGNS LIST

1, 1A, 1B, 1C: PORTABLE TERMINAL
10: PROXIMITY DETECTION UNIT
11: PROXIMITY COORDINATE EVALUATION UNIT
20: TOUCH DETECTION UNIT
21: TOUCH COORDINATE EVALUATION UNIT
30, 30A: KEY POSITION/FINGER POSITION DETERMINATION UNIT
30B: BUTTON POSITION/FINGER POSITION DETERMINATION UNIT
32: TRAJECTORY DETECTION POSITION/FINGER POSITION DETERMINATION UNIT
40, 40A: KEYBOARD APPLICATION
40B: CAMERA APPLICATION
40C: SECURITY LOCK APPLICATION
47: TRAJECTORY MATCHING DETERMINATION UNIT
50: SCREEN DISPLAY UNIT
51: KEY IMAGE COMBINING UNIT
52: ENLARGED KEY IMAGE GENERATION UNIT
53, 53A: KEY IMAGE COMBINING UNIT
54: DISPLAY TARGET KEY DETERMINATION UNIT
55: DISPLAY TARGET KEY IMAGE GENERATION UNIT
56: BUTTON EXECUTION CONTENT DETERMINATION UNIT
57: DISPLAY VARIABLE BUTTON IMAGE GENERATION UNIT
58: CAMERA PREVIEW SCREEN GENERATION UNIT
59: CAMERA SCREEN COMBINING UNIT
60: TRAJECTORY HOLDING UNIT
61: TRAJECTORY IMAGE GENERATION UNIT
62: SECURITY LOCK SCREEN GENERATION UNIT
63: SECURITY LOCK SCREEN COMBINING UNIT

1. A display control device comprising:
a display unit that displays data on a screen;
a proximity detection unit that detects proximity of a finger to the screen and outputs a proximity detection signal;
a contact detection unit that detects a contact of the finger on the screen;
a display control unit that displays related information or support information regarding an item displayed at a proximity correspondence position on the screen, at the proximity correspondence position or in the vicinity of the proximity correspondence position with reference to the proximity detection signal, wherein the proximity correspondence position is a position on the screen corresponding to the proximity detection signal for the finger of which the proximity is detected; and
an operation execution unit that executes an operation corresponding to an item falling in a contact position where a contact of the finger on the related information or the support information is detected in accordance with the contact of the finger.

2. The display control device according to claim 1, wherein the display control unit enlargedly displays the item displayed at the proximity correspondence position and all items adjacent to the item displayed at the proximity correspondence position, as the related information or the support information.

3. The display control device according to claim 2, wherein, in a case where the finger of which the proximity is detected is moved so as to exceed a boundary of a display region of the item displayed at the proximity correspondence position before the enlarged display, the display control unit switches and displays all of the enlargedly displayed items according to the movement of the finger.

4. The display control device according to claim 2, wherein, in a case where the finger of which the proximity is detected is moved so as to exceed a boundary of a display region of the item displayed at the proximity correspondence position after the enlarged display, the display control unit switches and displays all of the enlargedly displayed items according to the movement of the finger.

5. The display control device according to claim 2, wherein, in a case where the finger of which the proximity is detected is moved so as to exceed a boundary of a display region of all of the enlargedly displayed items, the display control unit switches and displays all of the enlargedly displayed items according to a movement direction of the finger.

6. The display control device according to claim 3, wherein the display control unit enlargedly displays an item and all items adjacent to the item while centering on the item displayed at the proximity correspondence position after the finger is moved, according to the movement of the finger of which the proximity is detected.

7. The display control device according to claim 3, wherein the display control unit continuously enlargedly displays items which are displayed so as to be adjacent in a movement direction of the finger and erases the enlarged display of items which are displayed so as to be adjacent on an opposite side to the movement direction of the finger, with respect to the all of the enlargedly displayed items, according to the movement of the finger of which the proximity is detected.

8. The display control device according to claim 1, further comprising:
a display target item determination unit that determines a related item which is related to the item displayed at the proximity correspondence position, wherein
the display control unit displays the determined related item in a vicinity of the item displayed at the proximity correspondence position as the related information or the support information.

9. The display control device according to claim 1, further comprising:
an item operation determination unit that determines whether an item displayed on the screen is a setting changing item for causing the operation execution unit to execute predetermined setting changing or an operation execution item for causing the operation execution unit to execute a predetermined operation, wherein
the display control unit displays a plurality of setting changing items set in a same group as a single button in a transmissive manner with respect to the screen, and displays the plurality of setting changing items corresponding to the single button in a visually recognized manner in a case where the single button is displayed at the proximity correspondence position of the finger of which the proximity is detected.

10. The display control device according to claim 1, further comprising:
an item operation determination unit that determines whether an item displayed on the screen is a setting changing item for causing the operation execution unit to execute predetermined setting changing or an operation execution item for causing the operation execution unit to execute a predetermined operation, wherein
the display control unit displays the operation execution item in a transmissive manner with respect to the screen, and erases all other items displayed on the screen excluding the operation execution item in a case of displaying the operation execution item displayed in a transmissive manner at the proximity correspondence position of the finger of which the proximity is detected.

11. The display control device according to claim 1, further comprising:
a trajectory position determination unit that determines whether an input operation using the finger of which the proximity is detected is performed on an upper part of the screen, inside a first space proximity detection region from the screen to a first height, and inside a second space proximity detection region from the first space proximity detection region to a second height, wherein
the display control unit identifiably displays a trajectory position of the determined input operation using the finger, by using any one of display forms which respectively correspond to the upper part of the screen, the inside of the first space proximity detection region, and the inside of the second space proximity detection region.

12. A display control method for a display control device which displays data on a screen, the method comprising the steps of:
detecting proximity of a finger to the screen and outputs a proximity detection signal;
displaying related information or support information regarding an item displayed at a proximity correspondence position on the screen, at the proximity correspondence position or in a vicinity of the proximity correspondence position with reference to the proximity detection signal, wherein the proximity correspondence position is a position on the screen corresponding to the proximity detection signal for the finger of which the proximity is detected;
detecting a contact of the finger on the screen; and
executing an operation corresponding to an item falling in the proximity correspondence position or a contact position where the contact is detected in accordance with the proximity of the finger to or the contact of the finger on the related information or the support information.

13. A non-transitory computer-readable storage medium in which is stored a program causing a computer which is a display control device which displays data on a screen, to execute:
detecting proximity of a finger to the screen and outputs a proximity detection signal;
displaying related information or support information regarding an item displayed at a proximity correspondence position on the screen, at the proximity correspondence position or in the vicinity of the proximity correspondence position with reference to the proximity detection signal, wherein the proximity detection signal for the finger of which the proximity is detected;
detecting a contact of the finger on the screen; and
executing an operation corresponding to an item falling in the proximity correspondence position or a contact position where the contact is detected in accordance with the proximity of the finger to or the contact of the finger on the related information or the support information.
